(19) United States
(12) Patent Application Publication
(10) Pub. No.: US 2026/0325998 A1
(43) Pub. Date: Oct. 22, 2026

(54) FILTER SCREEN WITH ELECTRICAL CLEANING

(71) Applicant: Beckman Coulter, Inc., Brea, CA (US)

(72) Inventor: Eduardo Jose Delgado, Brea, CA (US)

(21) Appl. No.: 19/468,659

(22) Filed: Feb. 3, 2026

Related U.S. Application Data
(60) Provisional application No. 63/752,954, filed on Feb. 3, 2025.

(51) Int. Cl. B01D 35/06; B01D 29/05; B01D 29/66; B01D 37/00; G01N 1/30; G01N 1/34; G01N 1/38; G01N 15/01

(52) U.S. Cl. CPC B01D 35/06; B01D 29/05; B01D 29/66; B01D 37/00; G01N 1/30; G01N 1/34; G01N 1/38; G01N 15/01; B01D 2201/08; G01N 2001/386

(57) ABSTRACT

A biological analysis system includes a conduit configured to convey a biological sample. The biological analysis system also includes a filter positioned within the conduit. The biological analysis system also includes two electrodes, with each electrode at opposing sides of the filter.

### CROSS-REFERENCE TO RELATED APPLICATION

This application claims priority to U.S. Provisional Application No. 63/752,954 filed Feb. 3, 2025, and entitled “FILTER SCREEN WITH ELECTRICAL CLEANING,” the disclosure of which is hereby incorporated by reference in its entirety.

### BACKGROUND

Blood cell analysis is one of the most commonly performed medical tests for providing an overview of a patient's health status. A blood sample can be drawn from a patient's body and stored in a test tube containing an anticoagulant to prevent clotting. A whole blood sample normally comprises three major classes of blood cells including red blood cells (erythrocytes), white blood cells (leukocytes) and platelets (thrombocytes). Each class can be further divided into subclasses of members. For example, five major types or subclasses of white blood cells have different shapes and functions. White blood cells may include neutrophils, lymphocytes, monocytes, eosinophils, and basophils. There are also subclasses of the red blood cell types. The appearances of particles in a sample may differ according to pathological conditions, cell maturity and other causes. Red blood cell subclasses may include reticulocytes and nucleated red blood cells.

Traditional blood cell analysis techniques have utilized principles such as impedance or Coulter principle, and fluorescence or light scatter in order to count and measure cells. These techniques utilize indirect measurements and therefore may be limited in the amount and quality of information that can be provided. Additionally, slide review is a common secondary step where a test result will need further analysis (e.g., to confirm a result, or to assess some abnormality), which is typically done through an automated or manual slide imaging step. Another automated blood cell counting technique involves flow imagery. Flow imagery involves providing a narrow flow path through a digital imaging device, imaging the passage of blood cells through the flow path, and processing the images to count and measure the blood cells. Due to the small size of the flow path through the digital imaging device, any debris in the blood sample significantly larger than a white blood cell can possibly clog and obstruct the flow path. Additionally, flow imaging may utilize stains in order to help visualize a nucleus region of cells, but the use of these stains can introduce impurities into the fluid line and may cause carryover issues or buildup within the fluid delivery lines. Therefore, solutions are needed to effectively safeguard the flow path through the digital imaging device.

### SUMMARY

In one aspect of the disclosure, a biological analysis system includes a conduit configured to convey a biological sample. The biological analysis system also includes a filter positioned within the conduit. The biological analysis system also includes two electrodes, with each electrode at opposing sides of the filter.

In another aspect of the disclosure, a method includes positioning a filter within a conduit and arranging two electrodes on opposing sides of the filter. The method further includes passing an electrical current through the electrodes across the filter.

In another aspect of the disclosure, a biological analysis conduit includes a first tubing linked with a first electrode. A second tubing is linked with a second electrode. A filter is positioned between the first electrode and the second electrode.

In another aspect of the disclosure, a method of operating a filter in a biological analysis conduit is disclosed. The method includes directing a biological sample through the biological analysis conduit and through a screen of the filter in a first direction. The method further includes stopping flow of the biological sample through the biological analysis conduit and the screen. Electrical current is applied across the screen of the filter by applying electrical current to a first electrode and a second electrode. The screen of the filter is spaced between the first electrode and the second electrode. The method further includes flushing the screen by flowing a cleaning fluid through the screen and the biological analysis conduit in a second direction opposite the first direction.

In another aspect of the disclosure, a sample analysis system includes an imaging system with an imaging device and a flow cell comprising a flow passage passing through a field of view of the imaging device. The sample analysis system also includes a blood cell chamber with an outlet fluidically connected to the flow passage of the flow cell. A filtration system is between the flow cell and the blood cell chamber.

In another aspect of the disclosure, a filter assembly includes a filter housing that is electrically non-conductive. A filter passage extends through the filter housing. A first electrode at a first end of the filter passage and a second electrode is at a second end of the filter passage. A filter screen is in the filter passage and is between the first electrode and the second electrode.

### BRIEF DESCRIPTION OF THE DRAWINGS

FIG. 1 is a schematic diagram illustrating an example of a testing apparatus with at least one filtration system, an imaging system, and a non-imaging system for analyzing a biological fluid sample.

FIG. 2 is a schematic diagram of an example of a flow cell and imaging device of the imaging system from the testing apparatus from the example of FIG. 1.

FIG. 3A is a schematic diagram of an example of the filtration system from the testing apparatus of FIG. 1 with the filtration system in a filtration mode.

FIG. 3B is another schematic diagram of the filtration system from FIG. 3A in a maintenance mode.

FIG. 4 is a method diagram showing an operation of the filtration system.

FIG. 5A is a schematic diagram of another example of the filtration system from the testing apparatus of FIG. 1 with the filtration system in a filtration mode.

FIG. 5B is another schematic diagram of the filtration system from FIG. 5A in a maintenance mode.

FIG. 6A is a schematic diagram of another example of the filtration system from the testing apparatus of FIG. 1 with a first filter in a filtration mode and a second filter in a maintenance mode.

FIG. 6B is another schematic diagram of the filtration system from FIG. 6A with the first filter in the maintenance mode and the second filter in the filtration mode.

FIG. 7 is a cross-sectional view of an example filter of the filtration system of the testing apparatus of FIG. 1.

FIG. 8 is a cross-sectional view of another example filter of the filtration system of the testing apparatus of FIG. 1.

FIG. 9 is a cross-sectional view of another example filter of the filtration system of the testing apparatus of FIG. 1.

FIG. 10 is a cross-sectional view of another example filter of the filtration system of the testing apparatus of FIG. 1.

FIG. 11 is a schematic diagram illustrating another example of a testing apparatus with at least one filtration system, an imaging system, and a non-imaging system for analyzing a biological fluid sample.

While the above-identified drawing figures set forth one or more embodiments of the invention, other embodiments are also contemplated. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings. Like reference numerals identify similar structural elements.

### DETAILED DESCRIPTION

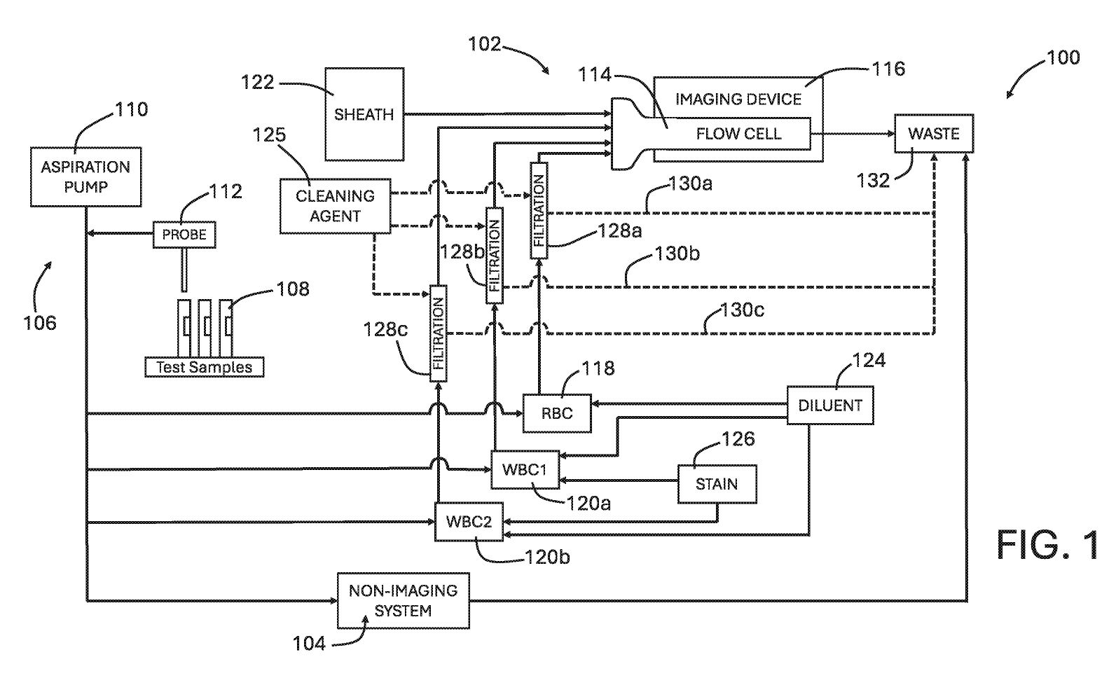

The present disclosure is directed to a filter and a filtration system for a testing apparatus that images and analyzes a biological fluid sample. The testing apparatus includes at least one preparation chamber for preparing the biological fluid sample with a diluent and/or stain, and a flow cell that receives the biological fluid sample in a flow for imaging and analysis of the biological fluid sample. A filtration system is connected fluidically between the preparation chamber and the flow cell. The filtration system includes a filter that removes debris from the biological fluid sample that is too large to pass through the flow cell. As discussed below with reference to FIGS. 1-9, the filtration system can include a first electrode and a second electrode that can apply a current across the filter to clean the filter between biological fluid samples.

FIG. 1 is a schematic diagram of an example of testing apparatus 100 with two different analytical or testing modules (e.g., imaging system 102 and non-imaging system 104). Testing apparatus 100 also includes sample aspiration module (SAM) 106 capable of providing fluid samples 108 to both imaging system 102 and non-imaging system 104. As shown in the example of FIG. 1, SAM 106 can include aspiration pump 110 and probe 112. Imaging system 102 includes flow cell 114, imaging device 116, red blood cell (RBC) chamber 118, first white blood cell (WBC) chamber 120a, second WBC chamber 120b, sheath fluid dispenser 122, diluent dispenser 124, cleaning agent dispenser 125, and stain dispenser 126. In the example of FIG. 1, imaging system 102 also includes first filtration system 128a, second filtration system 128b, third filtration system 128c, first flush line 130a, second flush line 130b, and third flush line 130c. Testing apparatus 100 can also include waste container 132 fluidically connected to both imaging system 102 and non-imaging system 104.

Fluid samples 108 can include whole blood samples gathered from test subjects and stored individually in containers that are labelled to identify the whole blood samples. Probe 112 draws one of fluid samples 108 into testing apparatus 100 and can separate the fluid sample 108 into predefined aliquots that are subsequently presented to imaging system 102 and/or non-imaging system 104. In the example of FIG. 1, probe 112 is fluidically connected to aspiration pump 110. Aspiration pump 110 can generate a vacuum at probe 112 that draws the fluid sample 108 from probe 112 and aspirates the fluid sample 108 before delivering the fluid sample 108 to imaging system 102 and/or non-imaging system 104. Probe 112 and aspiration pump 110 can deliver the fluid sample 108 to imaging system 102 by directing aliquots of the fluid sample 108 into at least one of RBC chamber 118, first WBC chamber 120a, and second WBC chamber 120b.

In RBC chamber 118, first WBC chamber 120a, or second WBC chamber 120b, an aliquot of the fluid sample 108 is treated and prepared before being directed by imaging system 102 toward flow cell 114 for imaging and analysis. First WBC chamber 120a or second WBC chamber 120b can be used to prepare another aliquot of the fluid sample 108 for imaging and analysis of white blood cells. In some examples, the imaging and analysis of the white blood cells can also include imaging and analysis for platelets. RBC chamber 118 is used by imaging system 102 to prepare an aliquot of the fluid sample 108 for imaging and analysis of red blood cells. In some examples, the imaging and analysis of red blood cells can also include imaging and analysis for platelets. In other examples, testing apparatus 100 can include a blood cell chamber that can prepare aliquots of the fluid sample 108 for both imaging of red blood cells and white blood cells.

In first WBC chamber 120a or second WBC chamber 120b, an aliquot of the fluid sample 108 can be mixed with diluent, a staining agent, and a lysing agent to create a mixed white blood cell sample that is also heated before delivery to imaging system 102. Diluent dispenser 124 is fluidically connected to first WBC chamber 120a and second WBC chamber 120b for metered delivery of the diluent to first WBC chamber 120a and second WBC chamber 120b. Diluent can be included in first WBC chamber 120a or second WBC chamber 120b to substantially dilute the aliquot of the fluid sample 108 and space the cells apart from each other for better viewing in imaging system 102. The diluent can be a saline solution or any other diluent suitable for diluting a blood sample.

Stain dispenser 126 is fluidically connected to both first WBC chamber 120a and second WBC chamber 120b for metered delivery of the staining agent and lysing agent to first WBC chamber 120a and second WBC chamber 120b. The staining agent and lysing agent can be combined together into a staining reagent before being delivered to first WBC chamber 120a and/or second WBC chamber 120b by stain dispenser 126 (e.g., the reagent being manufactured to have a staining agent and a lysing agent). In other examples, testing apparatus 100 can include a dedicated lyse dispenser that delivers the lysing agent to first WBC chamber 120a and/or second WBC chamber 120b while stain dispenser 126 only delivers the staining agent to first WBC chamber 120a and/or second WBC chamber 120b. Testing apparatus 100 can also include multiple stain dispensers 126 for metered delivery of different kinds of staining agent to first WBC chamber 120a and/or second WBC chamber 120b.

The lysing agent is included in first WBC chamber 120a and/or second WBC chamber 120b to eliminate red blood cells from the fluid sample 108. However, the lyse agent may still retain platelets and reticulocytes, so the aliquot of the fluid sample 108 prepared in first WBC chamber 120a and/or second WBC chamber 120b can still image at least white blood cells, platelets, and reticulocytes. The staining agent is included in first WBC chamber 120a and/or second WBC chamber 120b to permeate the membranes of remaining white blood cells in the fluid sample 108, stain the interior regions of the white blood cells, and repair the white blood cells so the stain does not escape from the interior regions of the white blood cells. The staining agent enhances contrast within the interior regions of the white blood cells such that the different kinds of white blood cells can be identified from each other, measured and counted. In some examples, the staining agent can utilize coloring agents such as fuchsin, new methylene blue, and/or crystal violet. The coloring agents and staining agents, along with other reagents used during sample preparation, can contribute to build-up into the fluid lines during the staining process and when routing stained blood samples to the flow cell for visualization, heightening the challenge in keeping the fluid lines clear and free of debris. More information on staining agents can be found in US Pat. No. 9279750 and US Pub. No. US2021/0108994, the contents of which are hereby incorporated by reference in their entirety.

Multiple different staining agents can be used in first WBC chamber 120a and/or second WBC chamber 120b to stain different cells in the fluid sample 108. For example, a first staining agent can be used to stain white blood cells, while a second staining agent can be used to stain platelets, and/or reticulocytes. In some examples, first WBC chamber 102a and/or second WBC chamber 120b can each be used to form the same kind of sample (such as two white blood cell samples from the same patient), such that two redundant samples can be sent separately to imaging system 102 for comparison and increased accuracy of testing apparatus 110. In other examples, first WBC chamber 120a can be used to prepare a first white blood sample from a first patient, while second WBC chamber 120b can be used to prepare a second white blood sample from a second patient.

In RBC chamber 118, an aliquot of the fluid sample 108 can be mixed with diluent to create a red blood cell sample that is heated before delivery to imaging system 102. In the example of FIG. 1, diluent dispenser 124 is fluidically connected to RBC chamber 118 for metered delivery of the diluent to RBC chamber 118. Similar to the discussion above relative to the white blood cell sample, diluent can be included in RBC chamber 118 to substantially dilute the aliquot of the fluid sample 108 and space the cells apart from each other in the red blood cell sample for better viewing in imaging system 102. A staining agent is not required to prepare the red blood cell sample for imaging. Since the staining agent is not required for the red blood cell sample, preparation of the red blood cell sample in RBC chamber 118 may be shorter in time than the preparation of the white blood cell sample in first WBC chamber 120a or second WBC chamber 120b. Since the red blood cell sample can be prepared faster than the white blood cell sample, the red blood cell sample in RBC chamber 118 can be sent to imaging system 102 first while the white blood cell sample is still undergoing preparation in first WBC chamber 120a or second WBC chamber 120b.

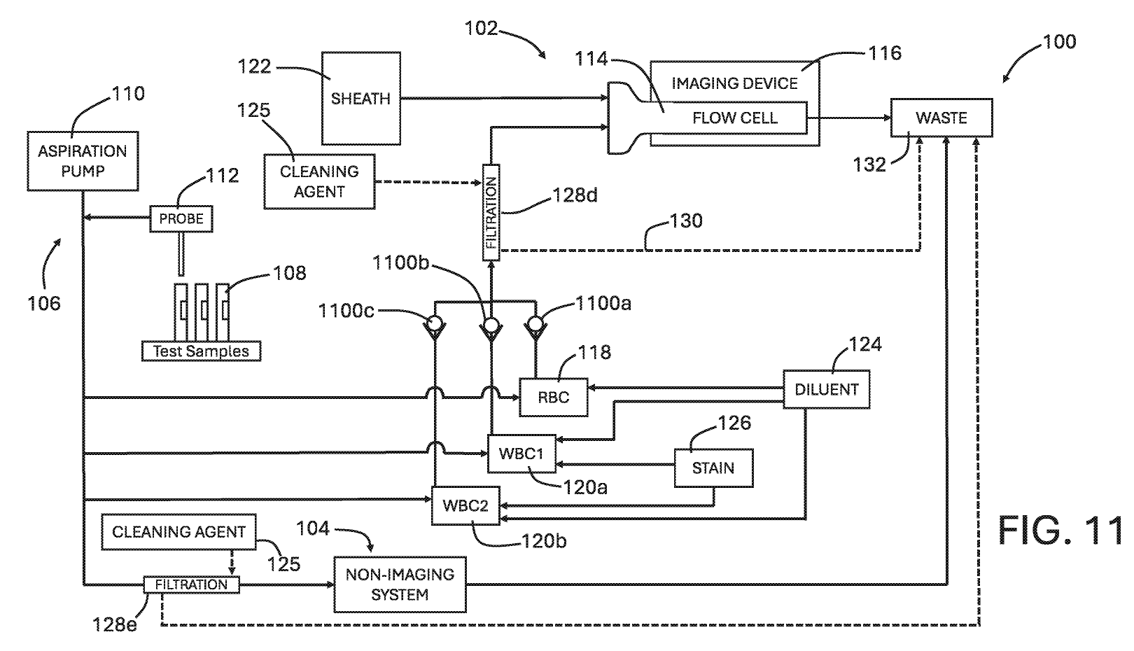

RBC chamber 118, first WBC chamber 120a, and second WBC chamber 120b are each fluidically connected to flow cell 114. In the example of FIG. 1, RBC chamber 118 is fluidically connected to flow cell 114 by first filtration system 128a, first WBC chamber 120a is fluidically connected to flow cell 114 by second filtration system 128b, and second WBC chamber 120b is fluidically connected to flow cell 114 by third filtration system 128c. In other examples, such as the one shown in FIG. 11, a single filtration system 128 can fluidically connect RBC chamber 118, first WBC chamber 120a, and second WBC chamber 120b to flow cell 114.

Referring again to FIG. 1, first filtration system 128a, second filtration system 128b, and third filtration system 128c screen and filter fluid samples before the fluid samples reach flow cell 114 to remove particles and debris from the samples that are too large for flow cell 114. To prevent clogging of filtration system 128a, second filtration system 128b, and third filtration system 128c over time, each of first filtration system 128a, second filtration system 128b, and third filtration system 128c is fluidically connected to cleaning agent dispenser 125 so that first filtration system 128a, second filtration system 128b, and third filtration system 128c can each be backflushed and cleaned after use. First filtration system 128a, second filtration system 128b, and third filtration system 128c are also each fluidically connected to waste container 132, which receives the cleaning agent and debris from first filtration system 128a, second filtration system 128b, and third filtration system 128c during the backflushing and cleaning process. The cleaning agent can include diluent, methanol, sodium hypochlorite, and/or other cleaning agents. In some examples, when diluent is used as the cleaning agent for backflushing first filtration system 128a, second filtration system 128b, and third filtration system 128c, diluent dispenser 124 can supply diluent to cleaning agent dispenser 125, or supply diluent directly to first filtration system 128a, second filtration system 128b, and third filtration system 128c. First filtration system 128a, second filtration system 128b, and third filtration system 128c can all be backflushed at the same time, or can be backflushed at different times from one another depending on the order in which fluid samples are being prepared in RBC chamber 118, first WBC chamber 120a, and second WBC chamber 120b and delivered to flow cell 114.

When the red blood cell sample in RBC chamber 118 is ready for imaging and analysis, testing apparatus 100 directs the red blood cell sample from RBC chamber 118 toward flow cell 114. First filtration system 128a is fluidically connected between RBC chamber 118 and flow cell 114, such that the red blood cell sample must flow through first filtration system 128a before reaching flow cell 114. First filtration system 128a includes a first filter that screens the red blood cell sample to catch debris (i.e., clumped masses of cells and fibrin) that is too large to pass through flow cell 114. Red blood cells and any other cells (such as platelets) or particles small enough to flow through flow cell 114 without clogging flow cell 114 are able to pass through first filtration system 128a. After passing through the first filtration system 128a, the red blood cell sample is directed to flow cell 114. At flow cell 114, the red blood cell sample is introduced into a flow of clear sheath fluid from sheath fluid dispenser 122, which aligns the cells and particles in the red blood cell sample into a thin ribbon flow that passes through flow cell 114. The thin ribbon flow passes through a field of view of imaging device 116. Imaging device 114 is a high optical resolution imaging device capable of imaging the microscopic cells and particles from the red blood cell sample passing through the flow cell 114. Imaging device 114 can be connected to a computer processor programed and trained to quickly recognize, count, and measure cells and particles in the red blood cell sample. After the red blood cell sample passes through flow cell 114, the red blood cell sample is fluidically directed to waste container 132 for safe disposal of the red blood cell sample. Flow cell 114 is also flushed and primed with clean diluent and/or clean sheath fluid to prepare flow cell 114 to receive the white blood cell sample from first WBC chamber 120a.

When the white blood cell sample in first WBC chamber 120a is ready for imaging and analysis, testing apparatus 100 fluidically directs the white blood cell sample from first WBC chamber 120a toward flow cell 114. Second filtration system 128b is fluidically connected between first WBC chamber 120a and flow cell 114, such that the white blood cell sample must flow through second filtration system 128b before reaching flow cell 114. Second filtration system 128b includes a second filter that screens the white blood cell sample to catch debris (i.e., clumped masses of cells and fibrin) that is too large to pass through flow cell 114. White blood cells, platelets, and any other cells or particles small enough to flow through flow cell 114 without clogging flow cell 114 are able to pass through second filtration system 128b. After passing through the second filtration system 128b, the white blood cell sample is directed to flow cell 114. At flow cell 114, the white blood cell sample is introduced into the flow of clear sheath fluid from sheath fluid dispenser 122, which aligns the white blood cells and other particles in the white blood cell sample into a thin ribbon flow that passes through flow cell 114. The thin ribbon flow passes through the field of view of imaging device 116 so that imaging device 114 can identify, count, and measure the white blood cells in the white blood cell sample. After the white blood cell sample passes through flow cell 114, the white blood cell sample is fluidically directed to waste container 132 for safe disposal of the white blood cell sample.

As the white blood cell sample is flowing through second filtration system 128b and flow cell 114, first filtration system 128a and RBC chamber 118 can both be flushed and cleaned. First flush line 130a can be fluidically connected to cleaning agent dispenser 125, first filtration system 128a, and waste container 132, and can be configured to flow a cleaning agent in reverse through first filtration system 128a to flush debris out of first filtration system 128a and directly to waste container 132. The cleaning agent can include diluent, methanol, sodium hypochlorite, and/or other cleaning agents. In some examples, the cleaning agent can be diluent supplied to cleaning agent dispenser 125 by diluent dispenser 124, or diluent dispenser 124 can also function directly as cleaning agent dispenser 125. After first filtration system 128a and RBC chamber 118 have been flushed and cleaned, RBC chamber 118 and first filtration system 128a are then primed with clean diluent so that RBC chamber 118 is ready to receive another aliquot of another fluid sample 108 to prepare a new red blood cell sample while imaging system 102 is still imaging and analyzing the white blood cell sample. After the white blood cell sample has passed through flow cell 114, flow cell 114 is flushed and primed again with clean diluent and/or clean sheath fluid to prepare flow cell 114 to receive the white blood sample from second WBC chamber 120b.

When the white blood sample in second WBC chamber 120b is ready for imaging and analysis, testing apparatus 100 fluidically directs the white blood sample from second WBC chamber 120b toward flow cell 114. Third filtration system 128c is fluidically connected between second WBC chamber 120b and flow cell 114, such that the white blood sample must flow through third filtration system 128c before reaching flow cell 114. Third filtration system 128c includes a third filter that screens the white blood sample to catch debris that is too large to pass through flow cell 114. White blood cells, platelets, and any other cells or particles small enough to flow through flow cell 114 without clogging flow cell 114 are able to pass through third filtration system 128c. After passing through third filtration system 128c, the white blood sample is fluidically directed to flow cell 114. At flow cell 114, the white blood sample is introduced into the flow of clear sheath fluid from sheath fluid dispenser 122, which aligns the white blood cells, platelets, and other particles in the white blood sample into a thin ribbon flow that passes through flow cell 114. The thin ribbon flow passes through the field of view of imaging device 116 so that imaging device 114 can identify, count, and measure the cells in the white blood sample. After the white blood sample passes through flow cell 114, the white blood sample is fluidically directed to waste container 132 for safe disposal of the white blood sample.

As the white blood sample from second WBC chamber 120b is flowing through third filtration system 128c and flow cell 114, second filtration system 128b and first WBC chamber 120a can both be flushed and cleaned. Second flush line 130b can be fluidically connected to cleaning agent dispenser 125, second filtration system 128b, and waste container 132, and can be configured to flow cleaning agent in reverse through second filtration system 128b to flush debris out of second filtration system 128b and directly to waste container 132. The cleaning agent can include diluent, methanol, sodium hypochlorite, and/or other cleaning agents. In some examples, the cleaning agent can be diluent supplied to cleaning agent dispenser 125 by diluent dispenser 124, or diluent dispenser 124 can also function directly as cleaning agent dispenser 125. After second filtration system 128b and first WBC chamber 120a have been flushed and cleaned, first WBC chamber 120a and second filtration system 128b are then primed with clean diluent so that first WBC chamber 120a is ready to receive another aliquot of another fluid sample 108 to prepare a new white blood cell sample while imaging system 102 is still imaging and analyzing the white blood sample from second WBC chamber 120b. After the white blood sample from second WBC chamber 120b has passed through flow cell 114, flow cell 114 is flushed and primed again with clean diluent and/or clean sheath fluid to prepare flow cell 114 to receive another red blood cell sample from RBC chamber 118.

As another red blood cell sample is flowing from RBC chamber 118 through first filtration system 128a and through flow cell 114, another white blood cell sample can be prepared and staged in first WBC chamber 120a, and third filtration system 128c and second WBC chamber 120b can both be flushed and cleaned. Third flush line 130c can be fluidically connected to cleaning agent dispenser 125, third filtration system 128c, and waste container 132, and can be configured to flow cleaning agent in reverse through third filtration system 128c to flush debris out of third filtration system 128c and directly to waste container 132. The cleaning agent can include diluent, methanol, sodium hypochlorite, and/or other cleaning agents. In some examples, the cleaning agent can be diluent supplied to cleaning agent dispenser 125 by diluent dispenser 124, or diluent dispenser 124 can also function directly as cleaning agent dispenser 125. After third filtration system 128c and second WBC chamber 120b have been flushed and cleaned, second WBC chamber 120b and third filtration system 128c are then primed with clean diluent so that second WBC chamber 120b is ready to receive another aliquot of another fluid sample 108 to prepare a new white blood sample.

Since the imaging system 102 can run a fluid sample from one of the three chambers through flow cell 114 while simultaneously preparing another fluid sample in another one of the chambers and simultaneously cleaning the third chamber and its associated filtration system, imaging system 102 is able to cycle fluid samples (red blood cell samples and white blood cell samples) through flow cell 114 at a relatively high rate. In some examples, the only rest period required by imaging system 102 between fluid samples is to flush and prime flow cell 114.

Testing apparatus 100 can include non-imaging system 104 as a secondary source of information using more traditional blood analysis techniques to confirm results, or to provide analysis for cell parameters that may be difficult to assess via imaging - for instance volumetric data such as mean corpuscular volume (MCV), or hemoglobin content of red blood cells. In various examples, the non-imaging system can include various combinations of impedance, conductivity, light scatter, volume-conductivity-scatter (VCS), fluorescence, and spectrophotometry modules. Further information on non-imaging system 104 is provided in international patent application number PCT/US2023/082530, entitled “HEMATOLOGY FLOW SYSTEM,” and filed Dec. 5, 2023, the disclosure of which is incorporated herein by reference in its entirety.

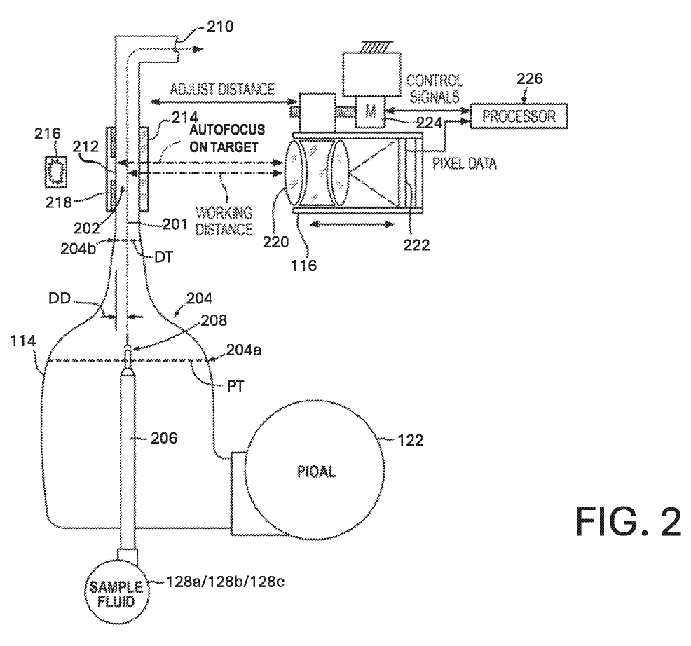

FIG. 2 is a schematic diagram of an example of flow cell 114 and imaging device 116 from testing apparatus 100 from the example of FIG. 1. As shown in FIG. 2, flow cell 114 and imaging device are analyzing a sample flow stream 201 formed from a sample fluid (shown in FIG. 1) supplied to flow cell 114. In the example of FIG. 2, flow cell 114 includes viewing zone 202, narrowing zone 204, sample feed tube 206 with distal end 208, and discharge outlet 210. Flow cell 114 can also include illumination opening 212 and viewing port 214. Imaging device 116 can include light source 216, autofocus target 218, objective lens 220, charge-coupled device (CCD) image sensor 222, motor drive 224, and processor 226.

In some examples, flow cell 114 may convey a sample fluid through a viewing zone 202 of imaging device 116 in a configuration for imaging microscopic particles in a sample flow stream 201 using digital image processing. Flow cell 114 can be fluidically coupled to a source of sample fluid to generate sample flow stream 201. As discussed above with reference to FIG. 1, the source of sample fluid for flow cell 114 can be first filtration system 128a, second filtration system 128b, or third filtration system 128c at any given time. When first filtration system 128a is selected as the source of sample fluid for flow cell 114, flow cell 114 receives a red blood cell sample that was previously processed in RBC chamber 118 and filtered through first filtration system 128a before arriving at flow cell 114. When second filtration system 128b is selected as the source of sample fluid for flow cell 114, flow cell 114 receives a white blood cell sample that was previously processed in first WBC chamber 120a and filtered through second filtration system 128b before arriving at flow cell 114. When third filtration system 128b is selected as the source of sample fluid for flow cell 114, flow cell 114 receives a white blood sample that was previously processed in second WBC chamber 120b and filtered through third filtration system 128c before arriving at flow cell 114.

Flow cell 114 is also fluidically coupled to one or more sheath fluid dispensers 122. As discussed above with reference to FIG. 1, sheath fluid dispenser 122 supplies sheath fluid to flow cell 114. The sheath fluid can also be referred to as a particle and/or intracellular organelle alignment liquid (PIOAL). Some examples of the sheath fluid include a clear glycerol solution with a viscosity that is greater than the viscosity of the sample fluid. In some examples, the sheath fluid includes iminodiac, a plurality of salts, bronidox, glycerol, and polyvinylpyrrolidone (PVP). Additional information on the sheath fluid (PIOAL) is provided in U.S. Patent No. 9,316,635, entitled “Sheath fluid systems and methods for particle analysis in blood samples,” issued on Apr. 19, 2016, the disclosure of which is hereby incorporated by reference in its entirety.

The sample fluid is injected as the sample flow stream 201 through a flattened opening at distal end 208 of sample feed tube 206, and into the interior of flow cell 114 at a point where the flow sheath fluid has been substantially established, resulting in a stable and symmetric laminar flow of the sheath fluid above and below (or on opposing sides of) the ribbon-shaped sample flow stream 201. The sample flow stream 201 and the sheath fluid streams may be supplied by precision metering pumps that move the sheath fluid with the injected sample flow stream along a flowpath of flow cell 114 that narrows substantially.

As shown in FIG. 2, the narrowing zone 204 can have a proximal flowpath portion 204a having a proximal thickness PT and a distal flowpath portion 204b having a distal thickness (DT), such that distal thickness DT is less than proximal thickness (PT). The sample flow stream 201 can therefore be injected through the distal end 208 of sample tube 206 at a location near to the proximal flowpath portion 204a. As the sample flow stream 201 exits distal end 208 of sample tube 206, the sheath fluid envelopes and compresses the sample flow stream 201 in the zone 204 of flow cell 114 where the flowpath of flow cell 114 narrows. The decrease in the flowpath thickness at zone 204 can contribute to a geometric focusing of the sample flow stream 201. The ribbon-shaped sample flow stream 201 is enveloped and carried along with the sheath fluid downstream of the narrowing zone 204 and through viewing zone 202 in front of imaging device 116.

Viewing port 214 is transparent and formed in viewing zone 202 so imaging device 116 can collect images of cells in the sample flow stream 201. Illumination opening 212 can be formed in view zone 202 of flow cell 114 opposite from viewing port 214 to allow light source 216 to shine into viewing zone 202 and backlight the sample flow stream 201. To collect images of the cells in the sample flow stream 201, imaging device 116 can use, for example, CCD image sensor 222. In this way, flow imaging is performed where images from the flowing sample stream and the cellular material contained therein are collected. Processor 226 can receive, as electrical input, pixel data from CCD 222. After passing through viewing zone 202, the sample flow stream 201 and the sheath fluid flow together through discharge outlet 210. Discharge outlet 210 can be fluidically connected to waste canister 132 shown in FIG. 1.

Objective lens 220 and CCD 222 of imaging device 116 can be aligned on an optical axis that intersects viewing port 214 and the sample flow stream 201. The relative distance between objective lens 220 can be adjusted by motor drive 224 in response to control signals from processor 226 so that CCD 222 captures focused digitized images of the sample flow stream 201. Autofocus target 218 can be fixed directly to flow cell 114, such as at the edges of illumination opening 212. Autofocus target 218 is generally at a constant displacement distance DD from the sample flow stream 201. The displacement distance DD is generally constant because the flow of the sheath fluid and the sample flow stream 201 is stable and laminar through flow cell 114. Processor 226 and motor drive 224 can use autofocus target 218 to arrive at the appropriate focal length for objective lens 220 that causes imaging device 116 to focus on sample flow stream 201. Additional information regarding the construction, operation, and autofocusing of imaging device 116 relative to flow cell 114 is provided in international patent application number PCT/US2023/082530, entitled “HEMATOLOGY FLOW SYSTEM,” and filed Dec. 5, 2023, the disclosure of which is incorporated herein by reference in its entirety. Additional information regarding the construction and operation of examples of flow cell 14 are provided in U.S. Pat. No. 9,322,752, entitled “Flowcell Systems and Methods for Particle Analysis in Blood Samples,” issued on Apr. 26, 2016, the disclosure of which is hereby incorporated by reference in its entirety; and/or U.S. Pat. No. 9,857,361, entitled “Flowcell, Sheath Fluid, and Autofocus Systems and Methods for Particle Analysis in Urine Samples,” issued on Jan. 2, 2018, the disclosure of which is hereby incorporated by reference in its entirety.

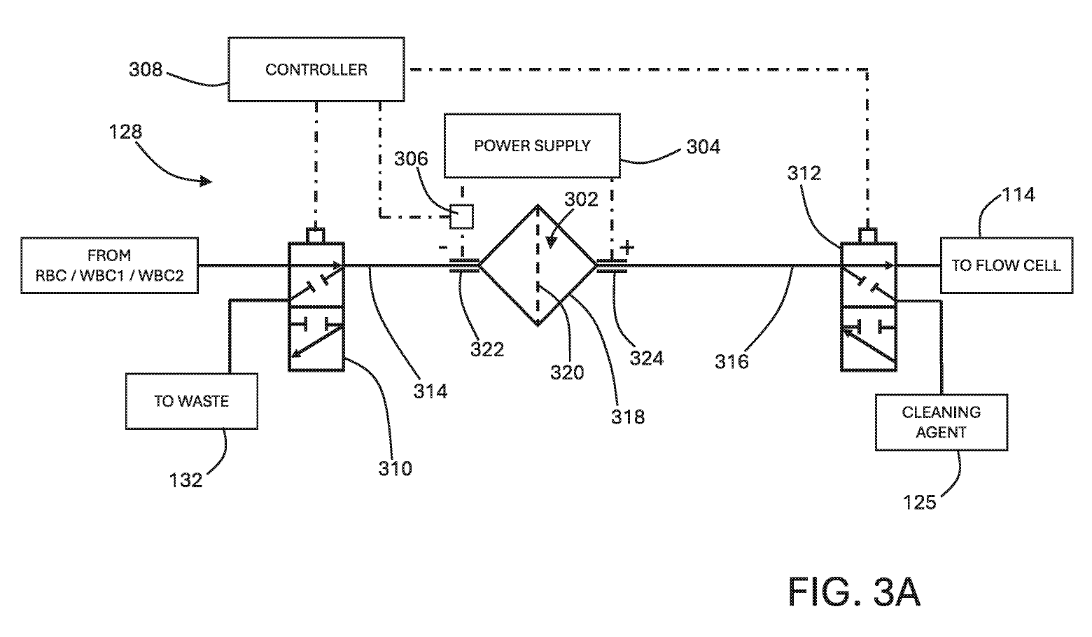

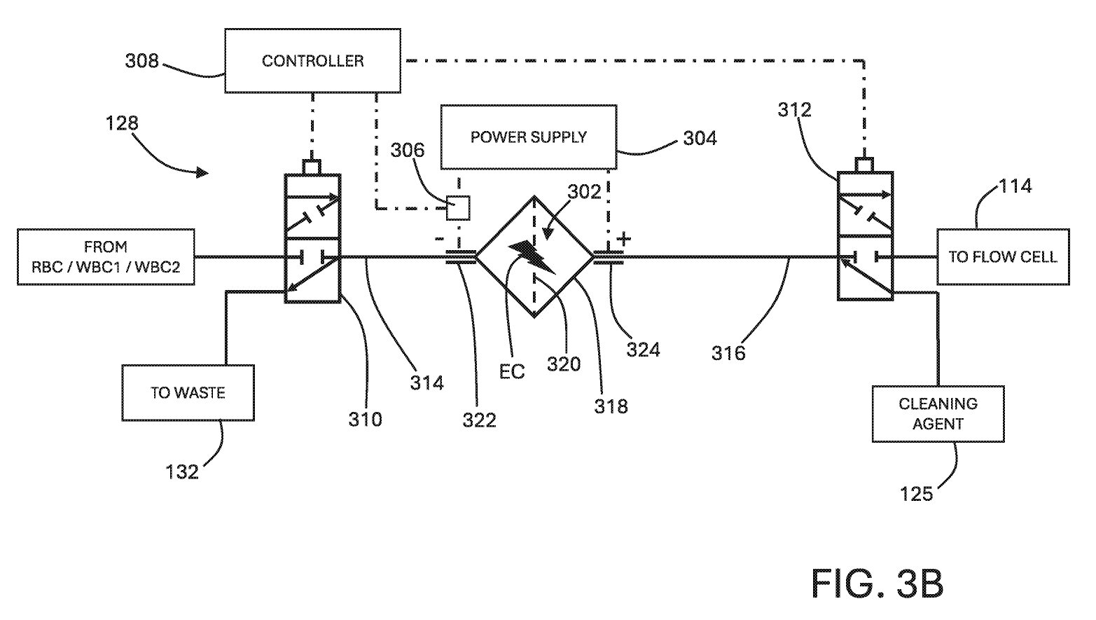

FIGS. 3A and 3B will be discussed concurrently. FIG. 3A is a schematic diagram of an example of filtration system 128 from testing apparatus 100 of FIG. 1. In the example of FIG. 3A, filtration system 128 is in a filtration mode. FIG. 3B is another schematic diagram of filtration system 128 from FIG. 3A in a maintenance mode. The example of filtration system 128 shown in FIGS. 3A and 3B can be representative of any of first filtration system 128a, second filtration system 128b, and third filtration system 128c from the example of FIG. 1. As shown in the example of FIGS. 3A and 3B, filtration system 128 includes filter 302, power supply 304, switch 306, controller 308, first valve 310, second valve 312, first fluid line 314, and second fluid line 316. Filter 302 includes filter housing 318, filter screen 320, first electrode 322, and second electrode 324.

First fluid line 314 and second fluid line 316 together form a conduit that is configured to direct flow of a fluid across filter 302. Filter 302 is fluidically connected to first valve 310 by first fluid line 314. First valve 310 includes a first position (shown in FIG. 3A) that fluidically connects first fluid line 314 to one of RBC chamber 118, first WBC chamber 120a, and second WBC chamber 120b (shown in FIG. 1), while also fluidically disconnecting first fluid line 314 from waste container 132. First valve 310 also includes a second position (shown in FIG. 3B) that fluidically connects first fluid line 314 to waste container 132 while also disconnecting first fluid line 314 from any of RBC chamber 118, first WBC chamber 120a, and second WBC chamber 120b. First valve 310 can be a first solenoid valve that is in electrical communication with controller 308. Controller 308 can send an electrical signal to actuate first valve 310 from the first position to the second position, and vice versa.

Filter 302 is fluidically connected to second valve 312 by second fluid line 316 such that filter 302 is fluidically connected between first valve 310 and second valve 312. Second valve 312 includes a first position (shown in FIG. 3A) that fluidically connects second fluid line 316 to flow cell 114 while also fluidically disconnecting second fluid line 316 from cleaning agent dispenser 125. Second valve 312 also includes a second position (shown in FIG. 3B) that fluidically connects second fluid line 316 to cleaning agent dispenser 125 while also disconnecting second fluid line 316 from flow cell 114. Second valve 312 can be a second solenoid valve that is in electrical communication with controller 308. Controller 308 can send an electrical signal to actuate second valve 312 from the first position of second valve 312 to the second position of second valve 312, and vice versa.

Filter housing 318 and filter screen 320 are positioned between first fluid line 314 and second fluid line 316 such that flow from first fluid line 314 must pass through filter screen 320 before continuing into second fluid line 316. Both first fluid line 314 and second fluid line 316 can be formed from an electrically non-conductive material, such as Teflon tubing. Filter housing 318 holds filter screen 320 in place transverse to a flowpath through filter housing 318. Filter housing 318 can be made from a plastic material or any other electrically non-conductive material. Filter screen 320 can comprise a nylon mesh with pores large enough to allow white blood cells, platelets, and red blood cells to pass through filter screen 320, but small enough to catch debris larger than white blood cells. For example, the pores of filter screen 320 can be within the range of 50 microns (µm) in diameter to 120 microns (µm) in diameter. Flow cell 114 includes a passage that narrows down to about 125 microns (µm) in diameter. Since the pores of filter screen 320 do not exceed 120 microns (µm) in diameter, filter screen 320 will capture and any debris large enough to possibly clog flow cell 114. While filter screen 320 is described as being formed from a nylon mesh, filter screen 320 can be formed from other electrically non-conductive materials that can be shaped into a mesh or screen, such as polytetrafluoroethylene (i.e., Teflon), ceramic, glass, or sapphire.

First electrode 322 is positioned on a first side of filter screen 320 and second electrode 324 is positioned on a second side of filter screen 320, such that filter screen 320 is positioned between first electrode 322 and second electrode 324. At least a portion of first electrode 322 is within first fluid line 314, or is coextensive with first fluid line 314, such that first electrode 322 contacts the fluid flow that passes through filtration system 128. At least a portion of second electrode 324 is within second fluid line 316, or is coextensive with second fluid line 316, such that second electrode 324 also contacts the fluid flow that passes through filtration system 128. Filter housing 318 spaces first electrode 322 and second electrode 324 from each other and also spaces first electrode 322 and second electrode 324 from filter screen 320.

Power supply 304 is electrically connected to first electrode 322 and second electrode 324. In the example of FIGS. 3A and 3B, power supply 304 is a high voltage power supply (e.g., at least 100V power supply). In some examples, power supply 304 is a direct current (DC) power supply. In other examples, power supply 304 is an alternating current (AC) power supply. In other examples, power supply 304 is a pulsed current or a pulse-width modulation (PWM) current. Switch 306 is connected electrically between power supply 304 and at least one of first electrode 322 and second electrode 324. Switch 306 is an electrical switch that is configured to open and close in response to an electrical signal from controller 308. When switch 306 is closed, electrical current can flow from power supply 304 and into second electrode 324. From second electrode 324, the current travels through the pores of filter screen 320 from second electrode 324 to first electrode 322. The current then passes from first electrode 322 back to power supply 304. When switch 306 is open, no electrical current flows between first electrode 322 and second electrode 324.

Controller 308 can be a system control module for all of testing apparatus 100 shown in FIG. 1. Controller 308 can communicate electrically with switch 306, first valve 310, and second valve 312. Controller 308 can also communicate electrically with any pump of testing apparatus 100 to stop and restart flow through filtration system 128 and any other part of testing apparatus 100. During operation of filtration system 128 in the filtration mode shown in FIG. 3A, controller 308 sends a signal to switch 306 to open switch 306 such that no electrical current is passing across filter 302. Controller 308 also sends a signal to first valve 310 and to second valve 312 to actuate both first valve 310 and second valve 312 to their respective first positions, as shown in FIG. 3A. With first valve 310 and second valve 312 both in their respective first positions, first fluid line 314 is fluidically connected to one of RBC chamber 118, first WBC chamber 120a, and second WBC chamber 120b by first valve 310 and receives a biological fluid sample (e.g., a red blood sample or a white blood sample). First fluid line 314 directs the biological fluid sample into filter housing 318. Inside filter housing 318, the biological fluid sample passes through filter screen 320. As the biological fluid sample passes through filter screen 318, filter screen 320 catches debris that is too large for flow cell 114 while allowing white blood cells, platelets, and red blood cells to pass through filter screen 320. After the biological fluid sample passes through filter screen 320, the biological fluid sample exits filter housing 318 and enters second fluid line 316. The second fluid line 316 directs the biological fluid sample into second valve 312. With second valve 312 in the first position, second valve 312 fluidically connects second fluid line 316 to a conduit leading to flow cell 114.

After the biological fluid sample has passed through filtration system 128, controller 308 can transition filtration system 128 to the maintenance mode shown in FIG. 3B. To transition filtration system 128 to the maintenance mode, controller sends a signal to first valve 310 and to second valve 312 to actuate both first valve 310 and second valve 312 to their respective second positions. With first valve 310 in the second position, first fluid line 314 is fluidically connected to waste container 132 while also disconnecting first fluid line 314 from any of RBC chamber 118, first WBC chamber 120a, and second WBC chamber 120b. With second valve 312 in the second position, second fluid line 316 is fluidically disconnected from flow cell 114 and fluidically connected to cleaning agent dispenser 125. Controller 308 can activate a pump (not shown) connected to cleaning agent dispenser 125 to flow cleaning agent in a reverse direction through filtration system 128. In the reverse direction through filtration system 128, the cleaning agent first flows into second valve 312, then into second fluid line 316, then through filter 302, then through first fluid line 314, and then through first valve 310. First valve 310 directs the cleaning agent exiting filtration system 128 to waste container 132. As the cleaning agent flows through filtration system 128 in the reverse direction, loose debris on filter screen 320 can be carried by the flow of cleaning agent out of filter 302 and to waste container 132. To further aid in cleaning of filter 302, cleaning agent dispenser 125 can flow the cleaning fluid through filter screen 320 at a flowrate that is two to three times faster than a flowrate that biological fluid samples pass through filter screen 320.

The cleaning agent can include diluent, methanol, sodium hypochlorite, and/or other cleaning agents. The cleaning agent is ionic so as to conduct electrical current. Once filtration system 128 has filled with the cleaning agent, controller 308 commands the pump connected to cleaning agent dispenser 125 to stop so that flow of the cleaning agent in filtration system 128 is stopped. After controller 308 has stopped the flow of the cleaning agent in filtration system 128, controller 308 sends a signal to switch 306 to close switch 306. With switch 306 closed, electrical current EC from power supply 304 flows into second electrode 324 and flows through the cleaning agent to first electrode 322 to return to power supply 304. As the electrical current EC flows in the cleaning agent from second electrode 324 to first electrode 322, the electrical current EC passes through the pores of filter screen 320. Since filter screen 320 and filter housing 318 are both electrically insulative, the electrical current EC must pass through the pores of filter screen 320 to reach first electrode 322. As the electrical current EC travels through the electrically conductive cleaning agent in the pores of filter screen 320, electrical resistance and voltage drop develops, which generates enough heat at the pores of filter screen 320 to cause the cleaning agent at the pores to vaporize. The vaporization of the cleaning agent at the pores of filter screen 320 generates vaporization forces in the cleaning agent at the pores that can dislodge from filter screen 320 any debris or buildup clogging pores on filter screen 320. The total duration of electrical current EC passing through the pores of filter screen 320 can be controlled by controller 308. For example, power supply 304 can be a 100V DC power supply, and controller 308 can apply the electrical current EC at a peak electrical current of 98mA across filter screen 320 for a total energized time of two seconds. In other examples, the electrical current EC can be applied to filter screen 320 for as little as 15 milliseconds.

After controller 308 has applied the electrical current EC across filter screen 320, controller 308 can send a signal to switch 306 to open switch 306 and stop the electrical current EC. Controller 308 can then send a command to the pump of cleaning agent dispenser 125 to restart flow of the cleaning agent in filtration system 128 to flush the debris shaken loose from the pores of filter screen 320. In some examples, controller 308 can cause multiple cycles of electrical current EC be applied to filter screen 320 to provide additional cleaning to filter screen 320. For example, after flushing away the debris knocked loose from filter screen 320 by a first application of the electrical current to filter screen 320, controller 308 can command the pump of cleaning agent dispenser 125 to again stop flow of the cleaning agent in filtration system 128, and controller 308 can send a signal to switch 306 to once again close switch 306 to reapply the electrical current EC across filter screen 320 from second electrode 324 to first electrode 322. The second application of the electrical current EC to filter screen 320 can knock loose any debris on filter screen 320 that was not dislodged by the first application of the electrical current EC to filter screen 320. After the second application of the electrical current EC to filter screen 320, controller 308 can send a signal to switch 306 to open switch 306 and stop the flow of the electrical current EC. Controller 308 can then send a signal to the pump of cleaning agent dispenser 125 to restart flow of the cleaning agent in the filtration system 128 to once again flush out any loose debris in filter 302 to waste container 132.

After filter screen 320 has been cleaned and loose debris in filtration system 128 has been flushed out of filtration system 128 to waste container 132, controller 308 can send a signal to first valve 310 and to second valve 312 to actuate both first valve 310 and second valve 312 back to their respective first positions, as shown in FIG. 3A. With first valve 310 and second valve 312 both back in their respective first positions, filtration system 128 is back in the filtration mode that fluidically connects filtration system 128 to flow cell 114 and one of RBC chamber 118, first WBC chamber 120a, and second WBC chamber 120b. Before receiving another biological fluid sample, filtration system 128 can receive clean diluent from one of RBC chamber 118, first WBC chamber 120a, or second WBC chamber 120b to flush the cleaning agent from filtration system 128. In other examples, filtration system 128 can be flushed by clean diluent from cleaning agent dispenser 125 at the end of the maintenance mode before controller 308 transitions filtration system 128 back to the filtration mode. After filtration system 128 has transitioned back to the filtration mode, filtration system 128 and flow cell 114 can be primed by a new biological fluid sample directed to filtration system 128 from one of RBC chamber 118, first WBC chamber 120a, and second WBC chamber 120b.

Since filter screen 320 can be cleaned of debris while in place in filtration system 128, filter screen 320 can be cleaned between each biological fluid sample without causing a significant delay. For example, initial tests show that the maintenance mode of filtration system 128 can be completed in as little as 15 seconds. By cleaning filter screen 320 between each biological fluid sample, filtration system 128 can continually prepare and direct biological fluid samples to flow cell 114 without a significant pause for maintenance. Thus, filtration system 128 allows flow cell 114 to remain in operation for a longer period of time, and to scan biological samples during that period of time, without lengthy pauses to disassemble and clean a filter.

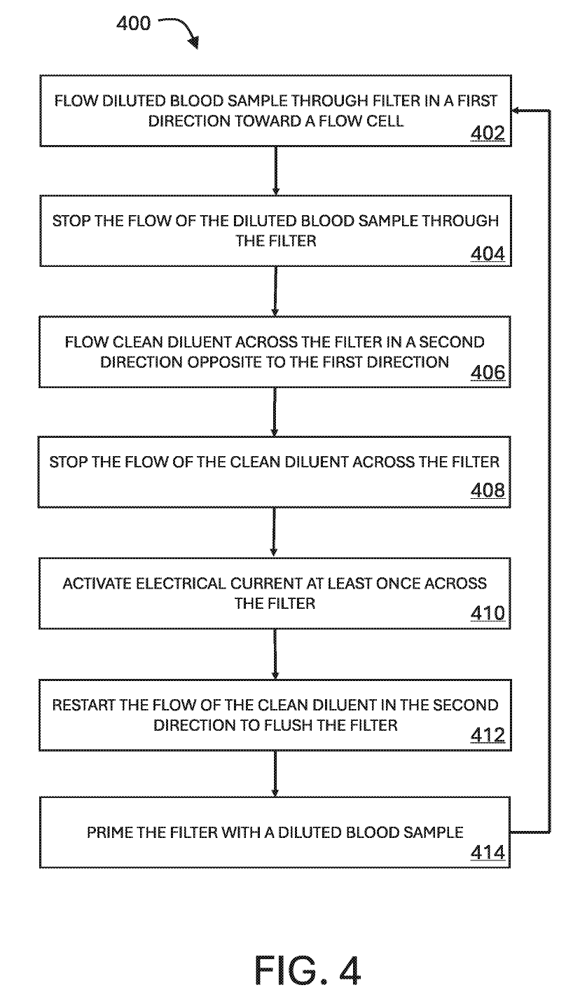

FIG. 4 is a diagram of a method 400 for operating filtration system 128. In a first step 402 of the method 400, a diluted biological fluid sample (e.g., a red blood cell sample or a white blood cell sample) flows through filter 302 of filtration system 128 in a first direction toward flow cell 114. In a second step 404 of the method 400, controller 308 stops the flow of the biological fluid sample through filter 302. In a third step 406 of the method 400, controller 308 causes clean diluent (or another cleaning agent) to flow across filter 302 in a second direction opposite to the first direction. In a fourth step 408 of the method 400, controller 308 causes the flow of diluent across filter 302 to stop. Then, in a fifth step 410 of the method 400, controller 308 causes an electrical current to be activated and applied at least once across filter screen 320 (e.g., current passing through the filter screen pores). In a sixth step 412 of the method 400, controller 308 causes the flow of diluent to restart across filter screen 320 in the second direction to flush debris from filter 302. In a seventh step 414 of the method 400, after filter 302 has been flushed clean, controller 308 can cause filtration system 128 to be primed by a new diluted biological fluid sample.

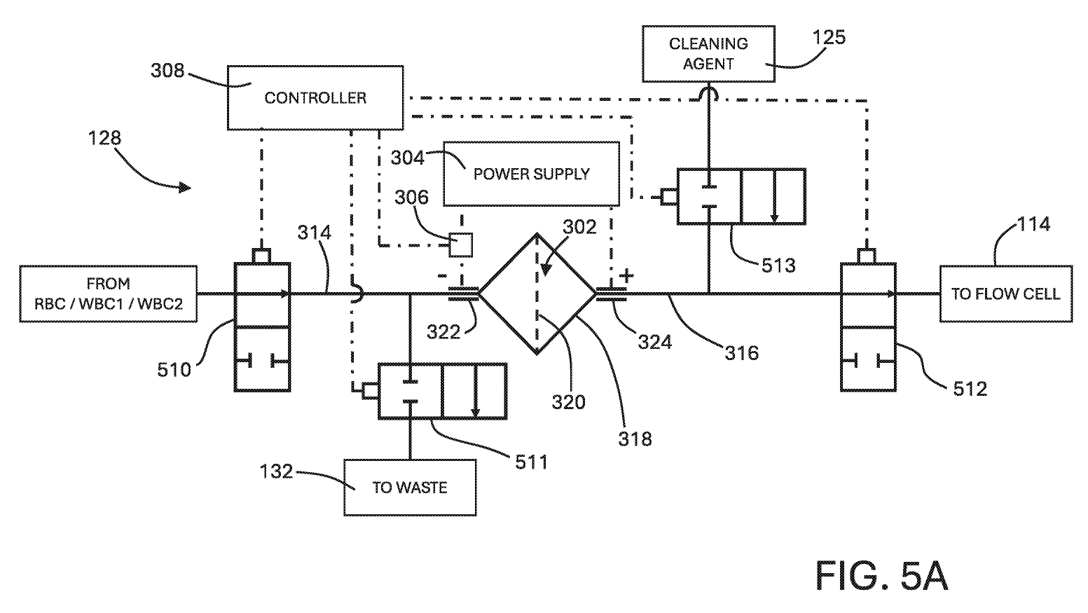

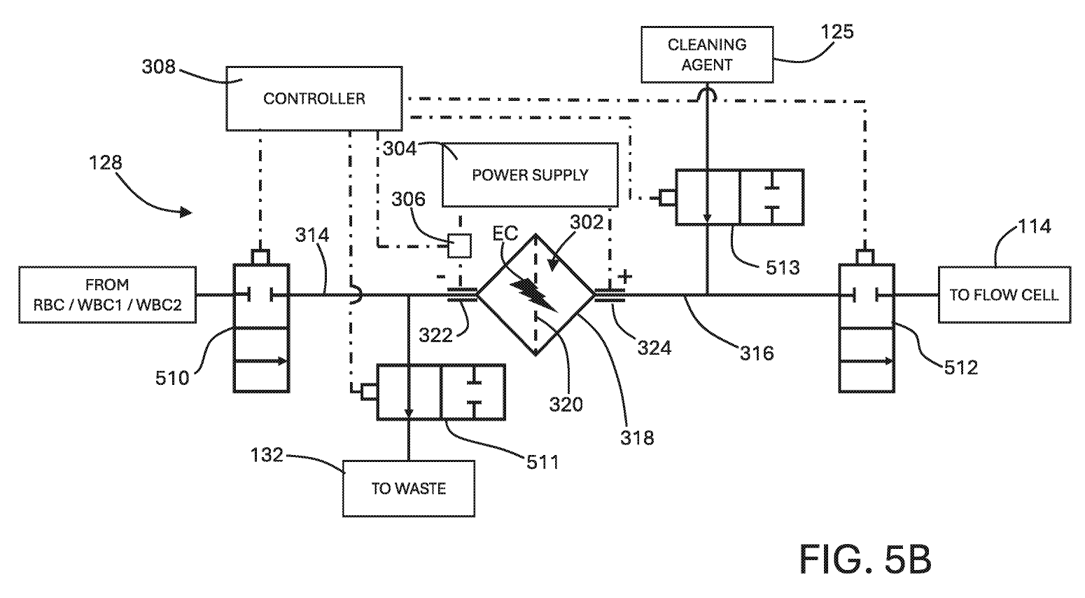

FIGS. 5A and 5B will be discussed concurrently. FIG. 5A is a schematic diagram of another example of filtration system 128 from testing apparatus 100 of FIG. 1. In the example of FIG. 5A, filtration system 128 is in a filtration mode. FIG. 5B is another schematic diagram of filtration system 128 from FIG. 5A, but in a maintenance mode. The example of filtration system 128 shown in FIGS. 5A and 5B can be representative of any of first filtration system 128a, second filtration system 128b, and third filtration system 128c from the example of FIG. 1. The example of filtration system 128 shown in FIGS. 5A and 5B is very similar to the example of filtration system 128 shown in FIGS. 3A and 3B, except first valve 310 from the example of FIGS. 3A and 3B has been replaced by first valve 510 and second valve 511, and second valve 312 from the example of FIGS. 3A and 3B has been replaced by third valve 512 and fourth valve 513. All other components of the example of filtration system 128 in FIGS. 5A and 5B are similarly configured and operate in a similar fashion to the corresponding components of the example of filtration system 128 in FIGS. 3A and 3B.

As shown in the example of FIG. 5A, first valve 510 fluidically connects first fluid line 314 to one of RBC chamber 118, first WBC chamber 120a, and second WBC chamber 120b when first valve 510 is in a first position. When first valve 510 is in the first position, first fluid line 314 can receive a biological fluid sample during the filtration mode of filtration system 128. When first valve 510 is in a second position (as shown in FIG. 5B), first valve 510 fluidically disconnects first fluid line 314 from RBC chamber 118, first WBC chamber 120a, and second WBC chamber 120b. First valve 510 fluidically disconnects first fluid line 314 from RBC chamber 118, first WBC chamber 120a, and second WBC chamber 120b during the maintenance mode to prevent contamination of those chambers.

Second valve 511 fluidically disconnects first fluid line 314 from waste container 132 when second valve 511 is in a first position and when filtration system 128 is in the filtration mode (as shown in FIG. 5A). Second valve 511 fluidically disconnects first fluid line 314 from waste container 132 during the filtration mode to prevent the biological fluid sample from going to waste container 132 instead of to filter 302. Second valve 511 fluidically connects first fluid line 314 to waste container 132 when second valve 511 is in a second position and filtration system 128 is in the maintenance mode (as shown in FIG. 5B). Second valve 511 fluidically connects first fluid line 314 to waste container 132 during the maintenance mode so that debris in filter 302 can be flushed to waste container 132. Both first valve 510 and second valve 511 can be solenoid valves that are electrically controlled by controller 308. Controller 308 can synchronize second valve 511 with first valve 510 such that second valve 511 is always in the first position when first valve 510 is in the first position, and second valve 511 is always in the second position when first valve 510 is in the second position.

Third valve 512 fluidically connects second fluid line 316 to flow cell 114 when in a first position (as shown in FIG. 5A), so that the biological fluid sample will flow to flow cell 114 after passing through filter 302 during the filtration mode of filtration system 128. Third valve 512 fluidically disconnects second fluid line 316 from flow cell 114 when third valve 512 is in a second position and when filtration system 128 is in the maintenance mode (as shown in FIG. 5B). By disconnecting flow cell 114 from second fluid line 316 during the maintenance mode of filtration system 128, third valve 512 in the second position prevents cleaning agent from flowing into the flow cell 114 instead of flowing through filter 302 and toward waste container 132.

Fourth valve 513 fluidically disconnects cleaning agent dispenser 125 from second fluid line 316 when in a first position and during the filtration mode of filtration system 128 (both shown in FIG. 5A). During the maintenance mode of filtration system 128 (shown in FIG. 5B), fourth valve 513 is in a second position that fluidically connects cleaning agent dispenser 125 to second fluid line 316 such that the cleaning agent can enter first fluid line 316, flow through filter 302, and pass through second filter 511 toward waste container 132. Both third valve 512 and fourth valve 513 can be solenoid valves that are electrically controlled by controller 308. Controller 308 can synchronize fourth valve 513 with third valve 512 such that fourth valve 513 is always in the first position when third valve 512 is in the first position, and fourth valve 513 is always in the second position when third valve 512 is in the second position. Controller 308 can also synchronize first valve 510, second valve 511, third valve 512, and fourth valve 513 together such that all of the valves move from their respective first positions to their respective second positions in unison, allowing filtration system 128 to very quickly transition from the filtration mode to the maintenance mode, and vice versa.

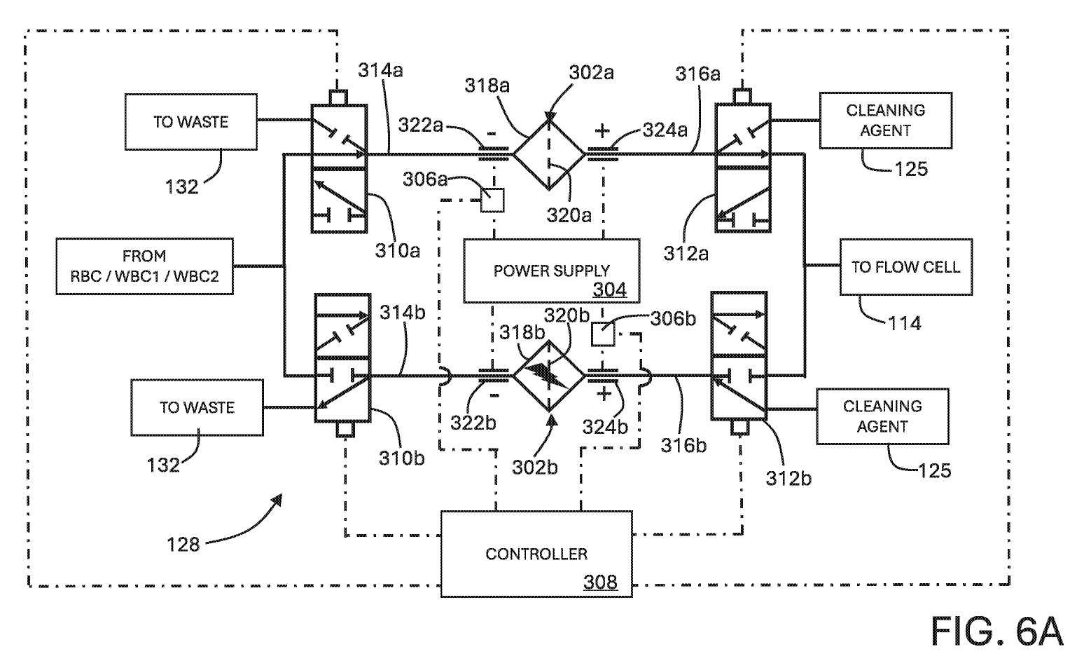

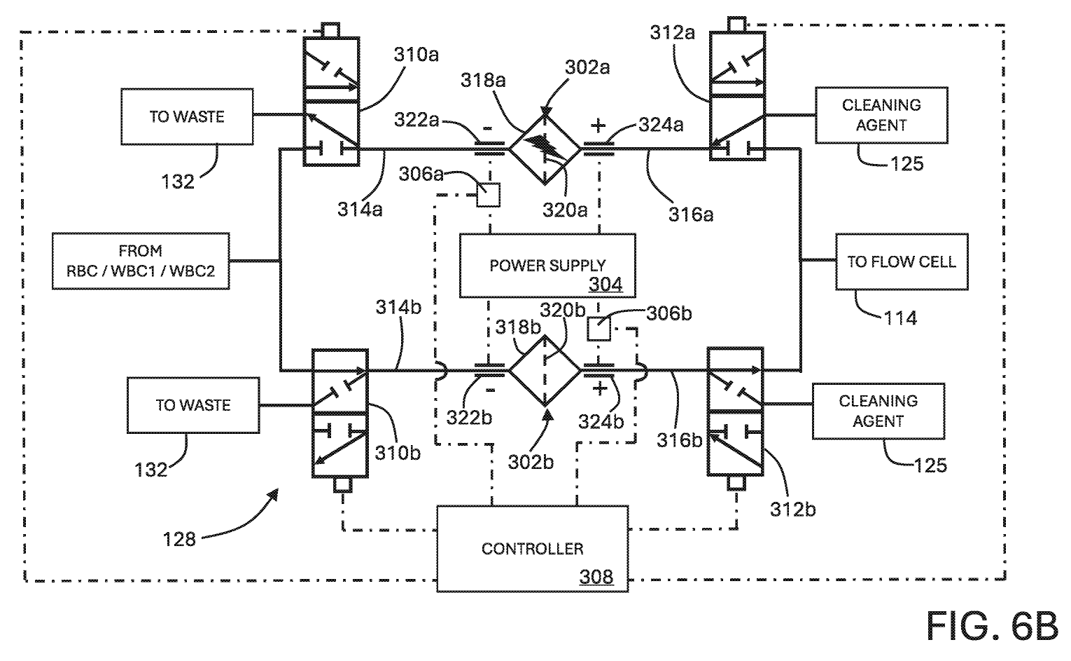

FIGS. 6A and 6B will be discussed concurrently. FIGS. 6A and 6B each show a schematic representation of another example of filtration system 128 from testing apparatus 100 of FIG. 1. In the example of FIGS. 6A and 6B, filtration system 128 includes first filter 302a and second filter 302b connected in parallel. FIG. 6A shows first filter 302a operating in the filtration mode while second filter 302b is operating in the maintenance mode. FIG. 6B shows first filter 302a operating in the maintenance mode while second filter 302b is operating in the filtration mode. In the example of FIGS. 6A and 6B, in addition to first filter 302a and second filter 302b, filtration system 128 further includes power supply 304, first switch 306a, second switch 306b, controller 308, first valve 310a, second valve 312a, third valve 310b, fourth valve 312b, first fluid line 314a, second fluid line 316a, third fluid line 314b, and fourth fluid line 316b. First filter 302a includes first filter housing 318a, first filter screen 320a, first electrode 322a, and second electrode 324a. Second filter 302b includes second filter housing 318b, second filter screen 320b, third electrode 322b, and fourth electrode 324b.

First fluid line 314a and second fluid line 316a together form a first conduit that is configured to direct flow of a fluid across first filter 302a. First filter 302a is fluidically connected to first valve 310a by first fluid line 314a. First valve 310a includes a first position (shown in FIG. 6A) that fluidically connects first fluid line 314a to one of RBC chamber 118, first WBC chamber 120a, and second WBC chamber 120b (shown in FIG. 1), while also fluidically disconnecting first fluid line 314a from waste container 132. First valve 310a also includes a second position (shown in FIG. 6B) that fluidically connects first fluid line 314a to waste container 132 while also disconnecting first fluid line 314a from RBC chamber 118, first WBC chamber 120a, and second WBC chamber 120b. First valve 310a can be a first solenoid valve that is in electrical communication with controller 308. Controller 308 can send an electrical signal to actuate first valve 310a from the first position to the second position, and vice versa.

First filter 302a is fluidically connected to second valve 312a by second fluid line 316a such that first filter 302a is fluidically connected between first valve 310a and second valve 312a. Second valve 312a includes a first position (shown in FIG. 6A) that fluidically connects second fluid line 316a to flow cell 114 while also fluidically disconnecting second fluid line 316a from cleaning agent dispenser 125. Second valve 312a also includes a second position (shown in FIG. 6B) that fluidically connects second fluid line 316a to cleaning agent dispenser 125 while also disconnecting second fluid line 316a from flow cell 114. Second valve 312a can be a second solenoid valve that is in electrical communication with controller 308. Controller 308 can send an electrical signal to actuate second valve 312a from the first position of second valve 312a to the second position of second valve 312a, and vice versa.

First filter housing 318a and first filter screen 320a are positioned between first fluid line 314a and second fluid line 316a such that flow from first fluid line 314a must pass through first filter screen 320a before continuing into second fluid line 316a. Both first fluid line 314a and second fluid line 316a can be formed from an electrically non-conductive material, such as polytetrafluoroethylene tubing (i.e., Teflon tubing). First filter housing 318a holds first filter screen 320a in place oblique to a flowpath through first filter housing 318a. First filter housing 318a can be made from a plastic material or any other electrically non-conductive material. First filter screen 320a can comprise a nylon mesh with pores large enough to allow white blood cells, platelets, and red blood cells to pass through first filter screen 320a, but small enough to catch debris larger than white blood cells. For example, the pores of first filter screen 320a can be within the range of 50 microns (µm) in diameter to 120 microns (µm) in diameter. While first filter screen 320a is described as being formed from a nylon mesh, first filter screen 320a can be formed from other electrically non-conductive materials that can be shaped into a mesh or screen, such as polytetrafluoroethylene (i.e., Teflon), ceramic, glass, or sapphire.

First electrode 322a is positioned on a first side of first filter screen 320a and second electrode 324a is positioned on a second side of first filter screen 320a, such that first filter screen 320a is positioned between first electrode 322a and second electrode 324a. At least a portion of first electrode 322a is within first fluid line 314a, or is coextensive with first fluid line 314a, such that first electrode 322a contacts the fluid flow that passes through first filter 302a. At least a portion of second electrode 324a is within second fluid line 316a, or is coextensive with second fluid line 316a, such that second electrode 324a also contacts the fluid flow that passes through first filter 302a. First filter housing 318a spaces first electrode 322a and second electrode 324a from each other and also spaces first electrode 322a and second electrode 324a from first filter screen 320a.

Power supply 304 is electrically connected to first electrode 322a and second electrode 324a. In the example of FIGS. 6A and 6B, power supply 304 is a high voltage power supply (e.g., at least 100V power supply). In some examples, power supply 304 is a direct current (DC) power supply. In other examples, power supply 304 is an alternating current (AC) power supply. In other examples, power supply 304 is a pulsed current or a pulse-width modulation (PWM) current. First switch 306a is connected electrically between power supply 304 and at least one of first electrode 322a and second electrode 324a. First switch 306a is an electrical switch that is configured to open and close in response to an electrical signal from controller 308. When first switch 306a is closed, electrical current can flow from power supply 304 and into second electrode 324a. From second electrode 324a, the current travels through the pores of first filter screen 320a from second electrode 324a to first electrode 322a. The current then passes from first electrode 322a back to power supply 304. When first switch 306a is open, no electrical current flows between first electrode 322a and second electrode 324a.

Third fluid line 314b and fourth fluid line 316b together form a second conduit that is configured to direct fluid flow across second filter 302b. The second conduit formed by third fluid line 314b and fourth fluid line 316b is parallel to the first conduit formed by first fluid line 314a and second fluid line 316a between flow cell 114 and RBC chamber 118, first WBC chamber 120a, and second WBC chamber 120b. Second filter 302b is fluidically connected to third valve 310b by third fluid line 314b. Third valve 310b includes a first position (shown in FIG. 6B) that fluidically connects third fluid line 314b to one of RBC chamber 118, first WBC chamber 120a, and second WBC chamber 120b, while also fluidically disconnecting third fluid line 314b from waste container 132. Third valve 310b also includes a second position (shown in FIG. 6A) that fluidically connects third fluid line 314b to waste container 132 while also disconnecting third fluid line 314b from RBC chamber 118, first WBC chamber 120a, and second WBC chamber 120b. Third valve 310b can be a third solenoid valve that is in electrical communication with controller 308. Controller 308 can send an electrical signal to actuate third valve 310b from the first position of third valve 310b to the second position of third valve 310b, and vice versa.

Second filter 302b is fluidically connected to fourth valve 312b by fourth fluid line 316b such that second filter 302b is fluidically connected between third valve 310b and fourth valve 312b. Fourth valve 312b includes a first position (shown in FIG. 6B) that fluidically connects fourth fluid line 316b to flow cell 114 while also fluidically disconnecting fourth fluid line 316b from cleaning agent dispenser 125. Fourth valve 312b also includes a second position (shown in FIG. 6A) that fluidically connects fourth fluid line 316b to cleaning agent dispenser 125 while also disconnecting fourth fluid line 316b from flow cell 114. Fourth valve 312b can be a fourth solenoid valve that is in electrical communication with controller 308. Controller 308 can send an electrical signal to actuate fourth valve 312b from the first position of fourth valve 312b to the second position of fourth valve 312b, and vice versa.

Second filter housing 318b and second filter screen 320b are positioned between third fluid line 314b and fourth fluid line 316b such that flow from third fluid line 314b must pass through second filter screen 320b before continuing into fourth fluid line 316b. Both third fluid line 314b and fourth fluid line 316b can be formed from an electrically non-conductive material, such as polytetrafluoroethylene tubing (i.e., Teflon). Second filter housing 318b holds second filter screen 320b in place oblique to a flowpath through second filter housing 318b. Second filter housing 318b can be made from a plastic material or any other electrically non-conductive material. Second filter screen 320b can comprise a nylon mesh with pores large enough to allow white blood cells, platelets, and red blood cells to pass through second filter screen 320b, but small enough to catch debris larger than white blood cells. For example, the pores of second filter screen 320b can be within the range of 50 microns (µm) in diameter to 120 microns (µm) in diameter. While second filter screen 320b is described as being formed from a nylon mesh, second filter screen 320b can be formed from other electrically non-conductive materials that can be shaped into a mesh or screen, such as polytetrafluoroethylene (i.e., Teflon), ceramic, glass, or sapphire.

Third electrode 322b is positioned on a first side of second filter screen 320b and fourth electrode 324b is positioned on a second side of second filter screen 320b, such that second filter screen 320b is positioned between third electrode 322b and fourth electrode 324b. At least a portion of third electrode 322b is within third fluid line 314b, or is coextensive with third fluid line 314b, such that third electrode 322b contacts the fluid flow that passes through second filter 302b. At least a portion of fourth electrode 324b is within fourth fluid line 316b, or is coextensive with fourth fluid line 316b, such that fourth electrode 324b also contacts the fluid flow that passes through second filter 302b. Second filter housing 318b spaces third electrode 322b and fourth electrode 324b from each other and also spaces third electrode 322b and fourth electrode 324b from second filter screen 320b.

Power supply 304 is electrically connected to third electrode 322b and fourth electrode 324b. Second switch 306a is connected electrically between power supply 304 and at least one of third electrode 322b and fourth electrode 324b. Second switch 306b is an electrical switch that is configured to open and close in response to an electrical signal from controller 308. When second switch 306b is closed, electrical current can flow from power supply 304 and into fourth electrode 324b. From fourth electrode 324b, the current travels through the pores of second filter screen 320b from fourth electrode 324b to third electrode 322b. The current then passes from third electrode 322b back to power supply 304. When second switch 306b is open, no electrical current flows between third electrode 322b and fourth electrode 324b. Controller 308 can be a system control module for all of testing apparatus 100 shown in FIG. 1. Controller 308 can communicate electrically with first switch 306a, second switch 306b, first valve 310a, second valve 312a, third valve 310b, and fourth valve 312b. Controller 308 can also communicate electrically with any pump of testing apparatus 100 to stop and restart flow through filtration system 128 and any other part of testing apparatus 100.

During operation of filtration system 128, controller 308 controls first valve 310a, second valve 312a, third valve 310b, and fourth valve 312b such that one of first filter 302a and second filter 302b is in the filtration mode to process a biological fluid sample while the other of first filter 302a and second filter 302b is in the maintenance mode and being cleaned. In the example of FIG. 6A, controller 308 sends a signal to first switch 306a to open switch 306a such that no electrical current is passing across first filter 302a. Controller 308 also sends a first control signal to first valve 310a and to second valve 312a to actuate both first valve 310a and second valve 312a to their respective first positions, as shown in FIG. 6A. With first valve 310a and second valve 312a both in their respective first positions, first fluid line 314a is fluidically connected to one of RBC chamber 118, first WBC chamber 120a, and second WBC chamber 120b by first valve 310a and able to receive a first biological fluid sample (e.g., a red blood sample or a white blood sample).

First fluid line 314a directs the first biological fluid sample into first filter housing 318a. Inside first filter housing 318a, the first biological fluid sample passes through first filter screen 320a. As the first biological fluid sample passes through first filter screen 318a, first filter screen 320a catches debris that is too large for flow cell 114 while allowing white blood cells, platelets, and red blood cells to pass through first filter screen 320a. After the first biological fluid sample passes through first filter screen 320a, the first biological fluid sample exits first filter housing 318a and enters second fluid line 316a. The second fluid line 316a directs the first biological fluid sample into second valve 312a. With second valve 312a in the first position, second valve 312a fluidically connects second fluid line 316a to a conduit leading to flow cell 114.

To ensure the first biological fluid sample passes through first filter 302a without diversion, controller 308 sends a second control signal to third valve 310b and to fourth valve 312b to actuate both third valve 310b and fourth valve 312b to their respective second positions as shown in FIG. 6A. With third valve 310b in the second position, third fluid line 314b is fluidically disconnected from the blood cell chamber sending the first biological fluid sample to filtration system 128. With fourth valve 310b in the second position, fourth fluid line 316b is fluidically disconnected from both flow cell 114 and second fluid line 316a. If a previously biological fluid sample had passed through second filter 302b, second filter 302b can be cleaned while third valve 310b and fourth valve 312b are in the second position. When third valve 310b is in the second position, third fluid line 314b is fluidically connected to waste container 132. When fourth valve 312b is in the second position, fourth fluid line 316b is fluidically connected to cleaning agent dispenser 125. Controller 308 can activate a pump connected to cleaning agent dispenser 125 to flow cleaning agent in a reverse direction through second filter 302b. In the reverse direction, the cleaning agent first flows into fourth valve 312b, then into fourth fluid line 316b, then through second filter 302b, then through third fluid line 314b, and then through third valve 310b. Third valve 310b directs the cleaning agent to waste container 132. As the cleaning agent flows through second filter 302b in the reverse direction, loose debris on second filter screen 320b can be carried by the flow of the cleaning agent out of second filter 302b and to waste container 132. To further aid in cleaning of second filter 302b, cleaning agent dispenser 125 can flow the cleaning fluid through second filter screen 320b at a flowrate that is two to three times faster than the flowrate at which the first biological fluid sample passes through first filter screen 320a.

The cleaning agent can include diluent, methanol, sodium hypochlorite, and/or other cleaning agents. The cleaning agent is ionic so as to conduct electrical current. Once second filter 302b has filled with the cleaning agent, controller 308 commands the pump connected to cleaning agent dispenser 125 to stop so that the flow of the cleaning agent in second filter 302b is stopped. After controller 308 has stopped the flow of the cleaning agent in second filter 302b, controller 308 sends a signal to second switch 306b to close second switch 306b. With second switch 306b closed, electrical current from power supply 304 flows into fourth electrode 324b and flows through the cleaning agent to third electrode 322b to return to power supply 304. As the electrical current flows in the cleaning agent from fourth electrode 324b to third electrode 322b, the electrical current passes through the pores of second filter screen 320b. Since second filter screen 320b and second filter housing 318b are both electrically insulative, the electrical current must pass through the pores of second filter screen 320b to reach third electrode 322b. As the electrical current travels through the electrically conductive cleaning agent in the pores of second filter screen 320b, electrical resistance and voltage drop develops, which generates enough heat at the pores of second filter screen 320b to cause the cleaning agent at the pores to vaporize. The vaporization of the cleaning agent at the pores of second filter screen 320b generates vaporization forces in the cleaning agent at the pores that can dislodge from second filter screen 320b any debris or buildup clogging the pores on second filter screen 320b. The total duration of the electrical current passing through the pores of second filter screen 320b can be controlled by controller 308. For example, power supply 304 can be a 100V DC power supply, and controller 308 can apply the electrical current at a peak of 98mA across second filter screen 320b for a total energized time of two seconds.

After controller 308 has applied the electrical current across second filter screen 320b, controller 308 can send a signal to second switch 306b to open second switch 306b and stop the electrical current. Controller 308 can then send a command to the pump of cleaning agent dispenser 125 to restart flow of the cleaning agent across second filter 302b to flush the debris shaken loose from the pores of second filter screen 320b. In some examples, controller 308 can cause multiple cycles of the electrical current to be applied to second filter screen 320b to provide additional cleaning to second filter screen 320b. For example, after flushing away the debris knocked loose from second filter screen 320b by a first application of the electrical current to second filter screen 320b, controller 308 can command the pump of cleaning agent dispenser 125 to again stop flow of the cleaning agent in second filter 302b, and controller 308 can send a signal to second switch 306b to once again close second switch 306b to reapply the electrical current across second filter screen 320b from fourth electrode 324b to third electrode 322b. The second application of the electrical current to second filter screen 320b can knock loose any debris on second filter screen 320b that was not dislodged by the first application of the electrical current to second filter screen 320b. After the second application of the electrical current to second filter screen 320b, controller 308 can send a signal to second switch 306b to open second switch 306b and stop the electrical current. Controller 308 can then send a signal to the pump of cleaning agent dispenser 125 to restart flow of the cleaning agent in second filter 302b to once again flush out any loose debris in second filter 302b to waste container 132.

After the first biological fluid sample has passed through first filter 302a to flow cell 114, and after second filter 302b has been cleaned, controller 308 sends a third control signal to first valve 310a and second valve 312a to actuate first valve 310a and actuate second valve 312a to their respective second positions (shown in FIG. 6B). Controller 308 also sends a fourth control signal to third valve 310b and fourth valve 312b to actuate third valve 310b and actuate fourth valve 312b to their respective first positions (shown in FIG. 6B). With first valve 310a and second valve 312a in the second position, first filter 302a is in the maintenance mode and prepared for cleaning. With third valve 310b and fourth valve 312b in the first position, second filter 302b is in the filtration mode and prepared to receive a second biological fluid sample.

In the example of FIG. 6B, with third valve 310b and fourth valve 312b both in their respective first positions, third fluid line 314b is fluidically connected to one of RBC chamber 118, first WBC chamber 120a, and second WBC chamber 120b by third valve 310b and able to receive a second biological fluid sample (e.g., a red blood sample or a white blood sample). Third fluid line 314b directs the second biological fluid sample into second filter housing 318b. Inside second filter housing 318b, the second biological fluid sample passes through second filter screen 320b. As the second biological fluid sample passes through second filter screen 318b, second filter screen 320b catches debris that is too large for flow cell 114 while allowing white blood cells, platelets, and red blood cells to pass through second filter screen 320b. After the second biological fluid sample passes through second filter screen 320b, the second biological fluid sample exits second filter housing 318b and enters fourth fluid line 316b. The fourth fluid line 316b directs the second biological fluid sample into fourth valve 312b. With fourth valve 312b in the first position, fourth valve 312b fluidically connects fourth fluid line 316b to a conduit leading to flow cell 114. The second biological fluid sample passes through fourth valve 312b and onto flow cell 114. The second biological fluid sample continues to flow cell 114 without diversion into first filter 302a because first valve 310a and second valve 312a are in their respective second positions.

With first valve 310a in the second position, first fluid line 314a is fluidically disconnected from the blood cell chamber sending the second biological fluid sample to filtration system 128. With second valve 310a in the second position, second fluid line 316a is fluidically disconnected from both flow cell 114 and fourth fluid line 316b. While the second biological fluid sample is passing through second filter 302b, first filter 302a can be cleaned of any debris first filter 302a captured from the first biological fluid sample. When first valve 310a is in the second position, first fluid line 314a is fluidically connected to waste container 132. When second valve 312a is in the second position, second fluid line 316a is fluidically connected to cleaning agent dispenser 125. Controller 308 can activate the pump connected to cleaning agent dispenser 125 to flow cleaning agent in a reverse direction through first filter 302a. In the reverse direction, the cleaning agent first flows into second valve 312a, then into second fluid line 316a, then through first filter 302a, then through first fluid line 314a, and then through first valve 310a. First valve 310a directs the cleaning agent to waste container 132. As the cleaning agent flows through first filter 302a in the reverse direction, loose debris on first filter screen 320a can be carried by the flow of the cleaning agent out of first filter 302a and to waste container 132. To further aid in cleaning of second filter 302b, cleaning agent dispenser 125 can flow the cleaning fluid through first filter screen 320a at a flowrate that is two to three times faster than the flowrate at which the second biological fluid sample passes through second filter screen 320b.

Once first filter 302a has filled with the cleaning agent, controller 308 commands the pump connected to cleaning agent dispenser 125 to stop so that the flow of the cleaning agent in first filter 302a is stopped. After controller 308 has stopped the flow of the cleaning agent in first filter 302a, controller 308 sends a signal to first switch 306a to close first switch 306a. With first switch 306a closed, electrical current from power supply 304 flows into second electrode 324a and flows through the cleaning agent to first electrode 322a to return to power supply 304. As the electrical current flows in the cleaning agent from second electrode 324a to first electrode 322a, the electrical current passes through the pores of first filter screen 320a. Since first filter screen 320a and first filter housing 318a are both electrically insulative, the electrical current must pass through the pores of first filter screen 320a to reach first electrode 322a. As the electrical current travels through the electrically conductive cleaning agent in the pores of first filter screen 320a, electrical resistance and voltage drop develops, which generates enough heat at the pores of first filter screen 320a to cause the cleaning agent at the pores to vaporize. The vaporization of the cleaning agent at the pores of first filter screen 320a generates vaporization forces in the cleaning agent at the pores that can dislodge from first filter screen 320a any debris or buildup clogging the pores on first filter screen 320a. The total duration of the electrical current passing through the pores of first filter screen 320a can be controlled by controller 308. For example, power supply 304 can be a 100V DC power supply, and controller 308 can apply the electrical current at a peak of 98m A across first filter screen 320a for a total energized time of two seconds.

After controller 308 has applied the electrical current across first filter screen 320a, controller 308 can send a signal to first switch 306a to open first switch 306a and stop the electrical current. Controller 308 can then send a command to the pump of cleaning agent dispenser 125 to restart flow of the cleaning agent across first filter 302a to flush the debris shaken loose from the pores of first filter screen 320a. In some examples, controller 308 can cause multiple cycles of the electrical current to be applied to first filter screen 320a to provide additional cleaning to first filter screen 320a. For example, after flushing away the debris knocked loose from first filter screen 320a by the first application of the electrical current to first filter screen 320a, controller 308 can command the pump of cleaning agent dispenser 125 to again stop flow of the cleaning agent in first filter 302a, and controller 308 can send a signal to first switch 306a to once again close first switch 306a to reapply the electrical current across first filter screen 320a from second electrode 324a to first electrode 322a. The second application of the electrical current to first filter screen 320a can knock loose any debris on first filter screen 320a that was not dislodged by the first application of the electrical current to first filter screen 320a. After the second application of the electrical current to first filter screen 320a, controller 308 can send a signal to first switch 306a to open first switch 306a and stop the electrical current. Controller 308 can then send a signal to the pump of cleaning agent dispenser 125 to restart flow of the cleaning agent in first filter 302a to once again flush out any loose debris in first filter 302a to waste container 132.

After the second biological fluid sample has passed through second filter 302b to flow cell 114, and after first filter 302a has been cleaned, controller 308 sends a signal to third valve 310b and fourth valve 312b to actuate third valve 310b and actuate fourth valve 312b to their respective second positions (shown in FIG. 6A). Controller 308 also sends a signal to first valve 310a and second valve 312a to actuate first valve 310a and actuate second valve 312a to their respective first positions (shown in FIG. 6A). With first valve 310a and second valve 312a in the first position, first filter 302a is in the filtration mode and prepared to receive a third biological fluid sample. With third valve 310b and fourth valve 312b in the second position, second filter 302b is in the maintenance mode and prepared to be cleaned again.

Since first filter 302a and second filter 302b can alternate between the maintenance mode and the filtration mode, filtration system 128 in the example of FIGS. 6A and 6B always has at least one filter available to screen a biological fluid sample for flow cell 114. Thus, with parallel first filter 302a and second filter 302b, filtration system 128 can continually supply biological fluid samples to flow cell 114 without requiring regular pauses for cleaning.

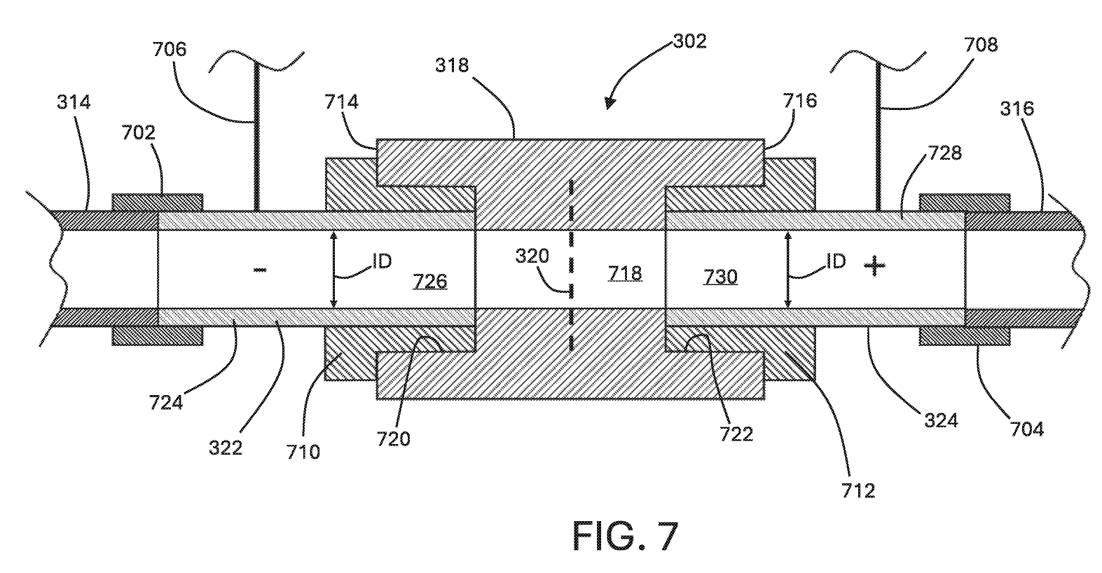

FIG. 7 shows a cross-sectional view of an example of filter 302. As shown in FIG. 7, filter 302 can be a filter assembly that includes filter housing 318, filter screen 320, first electrode 322, second electrode 324, first connector 702, second connector 704, first electrical lead 706, second electrical lead 708, first end cap 710, and second end cap 712. Filter housing 318 includes first end 714, second end 716, filter passage 718, first recess 720, and second recess 722. First electrode 322 includes first tube-shaped body 724 and first electrode passage 726. Second electrode 324 includes second tube-shaped body 728 and second electrode passage 730.

Filter housing 318 extends from first end 714 to second end 716. Filter housing 318 is formed from a material that is electrically non-conductive, such as plastic. Filter passage 718 is formed in filter housing 318 and extends completely through filter housing 318. Filter screen 320 is mounted in filter housing 318 such that filter screen 320 extends across filter passage 718. Filter screen 320 is also formed from a material that is electrically non-conductive, such as a nylon mesh. In other examples filter screen 320 can be formed from other electrically non-conductive materials that can be shaped into a mesh or screen, such as polytetrafluoroethylene (i.e., Teflon), ceramic, glass, or sapphire. Filter screen 320 can be embedded into filter housing 318 during a molding process of filter housing 318. Filter screen 320 can comprise a nylon mesh with pores large enough to allow white blood cells, platelets, and red blood cells to pass through filter screen 320, but small enough to catch debris larger than white blood cells. For example, the pores of filter screen 320 can be within the range of 50 microns (µm) in diameter to 120 microns (µm) in diameter. Flow cell 114 includes a passage that narrows down to about 125 microns (µm) in diameter. Since the pores of filter screen 320 do not exceed 120 microns (µm) in diameter, filter screen 320 will capture and any debris large enough to possibly clog flow cell 114. First recess 720 can extend into filter housing 318 from first end 714 and can be larger in diameter than filter passage 718 to accommodate first end cap 710 and first electrode 322. Second recess 722 can extend into filter housing 318 from send end 716 and can be larger in diameter than filter passage 718 to accommodate second end cap 710 and second electrode 324.

In the example of FIG. 7, first electrode 322 includes first tubed-shaped body 724 with first electrode passage 726 extending through first tube-shaped body 724. First tube-shaped body 724 is formed from an electrically conductive and chemically resistant material. For example, first tube-shaped body 724 can be formed from at least one of stainless steel, platinum, and palladium. First end cap 710 is connected to first electrode 322 and extends circumferentially about first tube-shaped body 724 of first electrode 322. First end cap 710 is sized to mate with first recess 720 of filter housing 318. In the example of FIG. 7, first end cap 710 can be made from a material similar to the material of filter housing 318, and first end cap 710 can be bonded to filter housing 318 to physically connect first electrode 322 to filter housing 318. With first end cap 710 in position in first recess 720, first electrode passage 726 is aligned with filter passage 718 and fluidically connected to a first end of filter passage 718. An inner diameter ID of first tube-shaped body 724 (which is also the diameter of first electrode passage 726) is approximately equal to a diameter of filter passage 718 at the first end of filter passage 718, such that there is a smooth transition from first electrode passage 726 to filter passage 718. The inner diameter ID of first tube-shaped body 724 is also approximately equal to an inner diameter of first fluid line 314, such that there is a smooth transition from first fluid line 314 to first electrode passage 718. In some examples, first fluid line 314, first electrode 322, and filter passage 718 can each include an inner diameter (flow passage diameter) of about 0.02 inches (0.508 mm).

Second electrode 324 includes second tubed-shaped body 728 with second electrode passage 730 extending through second tube-shaped body 728. Second tube-shaped body 728 is also formed from an electrically conductive and chemically resistant material. For example, second tube-shaped body 728 can be formed from at least one of stainless steel, platinum, and palladium. Second end cap 712 is connected to second electrode 324 and extends circumferentially about second tube-shaped body 728 of second electrode 324. Second end cap 712 is sized to mate with second recess 722 of filter housing 318. In the example of FIG. 7, second end cap 712 can be made from a material similar to the material of filter housing 318, and second end cap 712 can be bonded to filter housing 318 to physically connect second electrode 324 to filter housing 318. With second end cap 712 in position in second recess 722, second electrode passage 730 is aligned with filter passage 718 and fluidically connected to a second end of filter passage 718. An inner diameter ID of second tube-shaped body 728 (which is also the diameter of second electrode passage 730) is approximately equal to a diameter of filter passage 718 at the second end of filter passage 718, such that there is a smooth transition from filter passage 718 to second electrode passage 730. The inner diameter ID of second tube-shaped body 726 is also approximately equal to an inner diameter of second fluid line 316, such that there is a smooth transition from second electrode passage 718 to second fluid line 316. In some examples, second fluid line 316, second electrode 324, and filter passage 718 can each include an inner diameter (flow passage diameter) of about 0.02 inches (0.508 mm).

First electrical lead 706 electrically connects first electrode 322 to power supply 304 (shown in FIGS. 3A–6B). Second electrical lead 708 electrically connects second electrode 324 to power supply 304. First connector 702 connects first electrode 322 to first fluid line 314 such that first fluid line 314 is fluidically connected to first electrode passage 726. As discussed above with reference to FIGS. 3A–6B, first fluid line 314 can be selectively fluidically connected to a blood cell chamber to receive a biological fluid sample. Second connector 702 connects second electrode 324 to second fluid line 314 such that first fluid line 314 is fluidically connected to second electrode passage 730. As discussed above with reference to FIGS. 3A–6B, second fluid line 316 can be selectively fluidically connected to flow cell 114 to deliver a biological fluid sample to flow cell 114 after passing through filter screen 320. Together, first fluid line 314, first electrode 322, filter housing 318, second electrode 324, and second fluid line 316 form a conduit that can convey a biological fluid sample across filter screen 320. First fluid line 314 and second fluid line 316 are both made from an electrically non-conductive material, such as polytetrafluoroethylene tubing (i.e., Teflon tubing).

Filter passage 718 in filter housing 318 includes enough length that filter screen 320 is physically spaced between first electrode 322 and second electrode 324 and does not physically contact first electrode 322 and second electrode 324. During the maintenance mode of filter 302, discussed in detail above with reference to FIGS. 3A–6B, filter 302 can be cleaned by filling first electrode passage 726, filter passage 718, and second electrode passage 730 with an ionic cleaning solution and passing an electrical current from second electrode 324 to first electrode 322. As the electrical current passes from second electrode 324 to first electrode 322, the current must travel in the ionic cleaning solution through the pores of filter screen 320 since filter screen 320 and filter housing 318 are both made from electrically insulative material(s). As the current travels through the pores of filter screen 320, electrical resistance builds up in the pores, which causes the ionic cleaning solution in the pores to vaporize. The vaporization of the ionic solution in the pores generates enough forces to dislodge any residue or debris that may be clogging the pores. The debris shaken loose from filter screen 320 can be subsequently flushed from filter 302, as described above with reference to FIGS. 3A–6B.

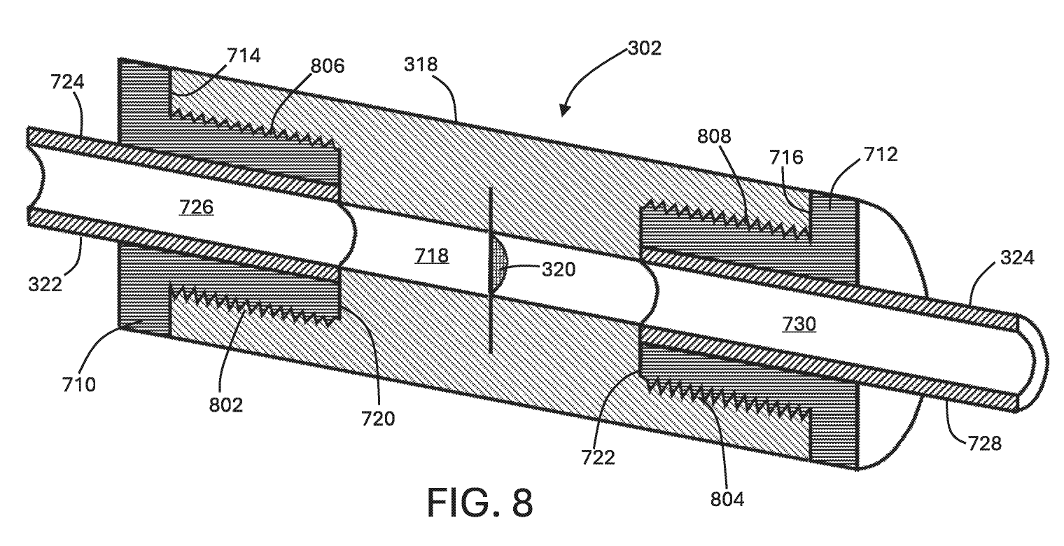

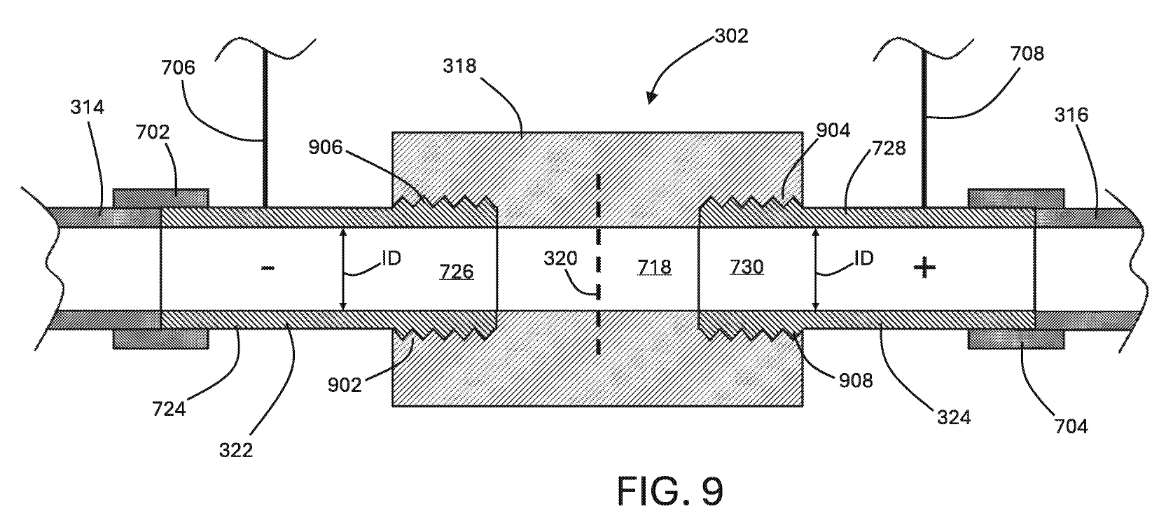

FIGS. 8 and 9 show additional examples of filter 302 with different means for connecting first electrode 322 and second electrode 324 to filter housing 318. As shown in the example of FIG. 8, first recess 720 of filter housing 318 can include first interior threading 802 and second recess 722 can include second interior threading 804. First end cap 710 can include first exterior threading 806 extending circumferentially about first end cap 710. Second end cap 712 can include second exterior threading 808 extending circumferentially about second end cap 710. First end cap 710 can be threaded into first recess 720 such that first exterior threading 806 of first end cap 710 engages and meshes with first interior threading of first recess 720 to form a threaded connection between first end cap 710 and filter housing 318. Second end cap 712 can be threaded into second recess 722 such that second exterior threading 808 of second end cap 712 engages and meshes with second interior threading of second recess 722 to form a threaded connection between second end cap 712 and filter housing 318.

In the example of FIG. 9, first end cap 710 and second end cap 712 are both omitted, and first electrode 322 and second electrode 324 are both connected directly to filter housing 318. In the example of FIG. 9, filter housing 318 includes first internally-threaded recess 902 at the first end of filter passage 718. Filter housing 318 also includes second internally-threaded recess 904 at the second end of filter passage 718. First electrode 322 includes first external threading 906 formed in first electrode 322 and extending circumferentially about first electrode 322. Second electrode 324 includes second external threading 908 formed in second electrode 324 and extending circumferentially about second electrode 324. In the example of FIG. 9, first electrode 322 is connected to filter housing 318 by threading first electrode 322 into first internally-threaded recess 902 such that a threaded connection is formed directly between first electrode 322 and filter housing 318. Second electrode 324 is connected to filter housing 318 by threading second electrode 324 into second internally-threaded recess 904 such that a threaded connection is formed directly between second electrode 324 and filter housing 318.

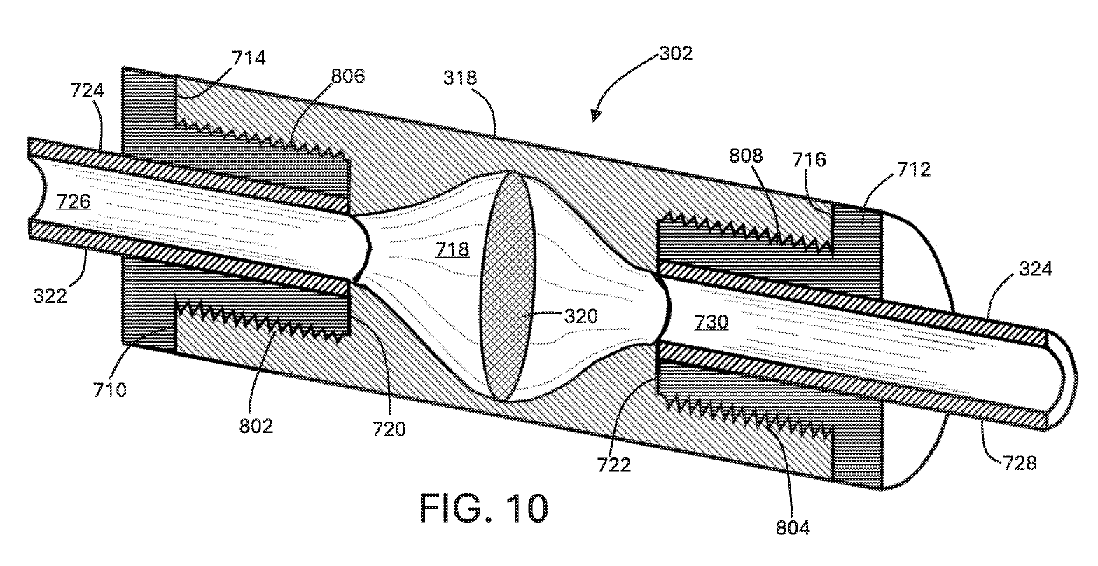

FIG. 10 is a cross-sectional view of another example of filter 302. In the example of FIG. 10, filter passage 718 increases in diameter as filter passage 718 extends from first electrode passage 726 toward filter screen 320. Filter passage 718 decreases in diameter as filter passage 718 extends from filter screen 320 toward second electrode passage 730. For example, filter passage 718 can transition from an inner diameter of 0.02 inches (0.508 mm) at the junction between filter passage 718 and first electrode passage 726 to an inner diameter of 0.20 inches (5.080 mm) or greater at filter screen 320. Filter passage 718 can then transition back to an inner diameter of 0.02 inches (0.508 mm) at the junction between filter passage 718 and second electrode passage 730. By transitioning filter passage 718 to a larger inner diameter at filter screen 320, filter passage 718 can accommodate a larger diameter filter screen 320. Increasing the diameter and size of filter screen 320 can help prevent filter screen 320 from creating back pressure in filter 302 and from lowering flow rates through filter 302, especially when the pores of filter screen 320 are on the smaller side (approaching 50 microns (µm) in diameter) of the working range of filter screen 320. The transition of the inner diameter of filter passage 718 can be smooth and tailored so as to minimize internal flow turbulence within filter passage 718 while also allowing effective cleaning of filter passage 718 (i.e., no sharp edges to trip flow or catch particulate).

FIG. 11 is a schematic diagram illustrating another example of testing apparatus 100 with a single filtration system 128d fluidically connecting each of RBC chamber 118, first WBC chamber 120a, and second WBC chamber 120b to flow cell 114. The example of testing apparatus 100 in FIG. 11 also includes filtration system 128e fluidically connected upstream of non-imaging system 104. All other parts of the example of testing apparatus 100 shown in FIG. 11 are similar to the example described above with reference to FIG. 1. Both filtration system 128d and filtration system 128e can each include any of the embodiments of filtration system 128 described above with reference to FIGS. 3A–10.

In the example of FIG. 11, filtration system 128d is fluidically connected between flow cell 114 and RBC chamber 118, first WBC chamber 120a, and second WBC chamber 120b and removes particles and debris from samples from RBC chamber 118, first WBC chamber 120a, and second WBC chamber 120b that are too large for flow cell 114. First check valve 1100a can be fluidically connected between filtration system 128d and RBC chamber 118. First check valve 1100a prevents backflow into RBC chamber 118 when a fluid sample is delivered to filtration system 128d and flow cell 114 from first WBC chamber 120a or second WBC chamber 120b. Second check valve 1100b can be fluidically connected between filtration system 128d and first WBC chamber 120a. Second check valve 1100b prevents backflow into first WBC chamber 120a when a fluid sample is delivered to filtration system 128d and flow cell 114 from RBC chamber 118 or second WBC chamber 120b. Third check valve 1100c can be fluidically connected between filtration system 128d and second WBC chamber 120b. Third check valve 1100c prevents backflow into second WBC chamber 120b when a fluid sample is delivered to filtration system 128d and flow cell 114 from RBC chamber 118 or first WBC chamber 120a.

To prevent clogging of filtration system 128d over time, filtration system 128d is fluidically connected to cleaning agent dispenser 125 so that filtration system 128d can be backflushed and cleaned after use. Filtration system 128d is also fluidically connected to waste container 132 by flush line 130, which receives the cleaning agent and debris from filtration system 128d during the backflushing and cleaning process. The cleaning agent can include diluent, methanol, sodium hypochlorite, and/or other cleaning agents. In some examples, when diluent is used as the cleaning agent for backflushing filtration system 128d, diluent dispenser 124 can supply diluent to cleaning agent dispenser 125, or supply diluent directly to filtration system 128d.

Filtration system 128e is positioned upstream of non-imaging system 104 and filters the fluid samples 108 to remove oversized particles and debris from the fluid samples 108 before the fluid samples 108 are delivered to non-imaging system 104. To prevent clogging of filtration system 128e, filtration system 128e is also fluidically connected to cleaning agent dispenser 125 so that filtration system 128e can be backflushed and cleaned after use. Filtration system 128e is also fluidically connected to waste container 132, which receives the cleaning agent and debris from filtration system 128e during the backflushing and cleaning process. The cleaning agent can include diluent, methanol, sodium hypochlorite, and/or other cleaning agents. In some examples, when diluent is used as the cleaning agent for backflushing filtration system 128e, diluent dispenser 124 can supply diluent to cleaning agent dispenser 125, or supply diluent directly to filtration system 128e.

### Discussion of Possible Embodiments

The following are non-exclusive descriptions of possible embodiments of the present invention.

In one aspect of the disclosure, a biological analysis system includes a conduit configured to convey a biological sample. The biological analysis system also includes a filter positioned within the conduit. The biological analysis system also includes two electrodes, with each electrode at opposing sides of the filter.

The biological analysis system of the preceding paragraph can optionally include, additionally and/or alternatively, any one or more of the following features, configurations and/or additional components in the paragraphs below.

In an embodiment of the biological analysis system, the filter is a mesh filter.

In an embodiment of the biological analysis system, the filter is a non-conductive filter.

In an embodiment of the biological analysis system, the conduit comprises a first tubing section and a second tubing section.

In an embodiment of the biological analysis system, at least a portion of a first electrode of the two electrodes is located within the first tubing section, and at least a portion of the second electrode of the two electrodes is located within the second tubing section.

In an embodiment of the biological analysis system, each electrode of the two electrodes has a tubular cross-section.

In an embodiment of the biological analysis system, the biological analysis system further comprising a housing, wherein the filter is positioned in the housing.

In an embodiment of the biological analysis system, each electrode has a threaded end configured to be secured to the housing.

In an embodiment of the biological analysis system, the electrodes and the conduit are configured to convey a biological sample.

In another aspect of the disclosure, a method includes positioning a filter within a conduit and arranging two electrodes on opposing sides of the filter. The method further includes passing an electrical current through the electrodes across the filter.

In another aspect of the disclosure, a biological analysis conduit includes a first tubing linked with a first electrode. A second tubing is linked with a second electrode. A filter is positioned between the first electrode and the second electrode.

In another aspect of the disclosure, a method of operating a filter in a biological analysis conduit is disclosed. The method includes directing a biological sample through the biological analysis conduit and through a screen of the filter in a first direction. The method further includes stopping flow of the biological sample through the biological analysis conduit and the screen. Electrical current is applied across the screen of the filter by applying electrical current to a first electrode and a second electrode. The screen of the filter is spaced between the first electrode and the second electrode. The method further includes flushing the screen by flowing a cleaning fluid through the screen and the biological analysis conduit in a second direction opposite the first direction.

The method of the preceding paragraph can optionally include, additionally and/or alternatively, any one or more of the following features, configurations and/or additional components in the paragraphs below.

In an embodiment of the method, the method further comprises flowing the cleaning fluid through the screen at a flowrate that is two to three times faster than a flowrate of the biological sample through the screen.

In an embodiment of the method, the method further comprises directing the cleaning fluid to a waste container after flushing the screen.

In an embodiment of the method, the method further comprises priming the biological analysis conduit and the filter by flowing a second biological sample through the biological analysis conduit and through the screen of the filter in the first direction after flushing the screen.

In an embodiment of the method, priming the biological analysis conduit and the filter further comprises: staining the second biological sample before flowing the second biological sample through the biological analysis conduit and through the screen of the filter in the first direction; and diluting the second biological sample before flowing the second biological sample through the biological analysis conduit and through the screen of the filter in the first direction.

In an embodiment of the method, the method further comprises: stopping flow of the cleaning fluid through the screen and the biological analysis conduit in the second direction; passing electrical current across the screen again by reapplying electrical current to the first electrode and the second electrode; and flushing the screen a second instance by restarting flow of the cleaning fluid through the screen and the biological analysis conduit in the second direction.

In another aspect of the disclosure, a sample analysis system includes an imaging system with an imaging device and a flow cell comprising a flow passage passing through a field of view of the imaging device. The sample analysis system also includes a blood cell chamber with an outlet fluidically connected to the flow passage of the flow cell. A filtration system is between the flow cell and the blood cell chamber.

The sample analysis system of the preceding paragraph can optionally include, additionally and/or alternatively, any one or more of the following features, configurations and/or additional components in the paragraphs below.

In an embodiment of the sample analysis system, the filtration system comprises: a filter comprising: a filter housing, wherein the filter housing is electrically non-conductive; a filter passage formed in the filter housing and extending through the filter housing; a first electrode at a first end of the filter passage; a second electrode at a second end of the filter passage; and a filter screen in the filter passage, wherein the filter screen is between the first electrode and the second electrode, wherein the first end of the filter passage is fluidically connected to the blood cell chamber, and wherein the second end of the filter passage is fluidically connected to the flow cell.

In an embodiment of the sample analysis system, the first electrode is tubular in shape and comprises an inner diameter approximately equal to a diameter of the filter passage at the first end of the filter passage, and wherein the second electrode is tubular in shape and comprises an inner diameter approximately equal to a diameter of the filter passage at the second end of the filter passage.

In an embodiment of the sample analysis system, the filter further comprises: a first end cap connected to the first electrode and extending circumferentially about the first electrode, wherein the first end cap comprises a first external threading that extends circumferentially about the first end cap and that engages a first internal threading of the filter housing; and a second end cap connected to the second electrode and extending circumferentially about the second electrode, wherein the second end cap comprises a second external threading that extends circumferentially about the second end cap and that engages a second internal threading of the filter housing.

In an embodiment of the sample analysis system, the first electrode comprises a first external threading that extends circumferentially about the first electrode and that engages a first internal threading of the filter housing; and the second electrode comprises a second external threading that extends circumferentially about the second electrode and that engages a second internal threading of the filter housing.

In an embodiment of the sample analysis system, the first electrode and the second electrode are each formed from at least one of stainless steel, platinum, and palladium.

In an embodiment of the sample analysis system, the filter screen is electrically non-conductive, and wherein the filter screen is spaced from both the first electrode and the second electrode such that the filter screen does not physically contact the first electrode nor the second electrode.

In an embodiment of the sample analysis system, the filtration system further comprises: a first valve fluidically connected between the blood cell chamber and the filter passage, wherein the first valve comprises: a first mode that fluidically connects the blood cell chamber to the filter passage while also fluidically disconnecting the filter passage from a waste container; and a second mode that fluidically disconnects the blood cell chamber from the filter passage while also fluidically connecting the filter passage to the waste container; and a second valve fluidically connected between the filter passage and the flow cell, wherein the second valve comprises: a first mode that fluidically connects the filter passage to the flow cell while also fluidically disconnecting the filter passage from a cleaning agent source; and a second mode that fluidically disconnects the filter passage from the flow cell while also fluidically connecting the filter passage to the cleaning agent source.

In an embodiment of the sample analysis system, the filtration system further comprises: a controller in electrical communication with the first valve and the second valve, and wherein the controller is configured to send a first control signal to the first valve and/or the second valve to simultaneously actuate both the first valve to the first mode of the first valve and the second valve to the first mode of the second valve, and wherein the controller is configured to send a second control signal to the first valve and/or the second valve to simultaneously actuate both the first valve to the second mode of the first valve and the second valve to the second mode of the second valve.

In an embodiment of the sample analysis system, the sample analysis system further comprises: a power source electrically connected to the first electrode and the second electrode; and an electrical switch electrically connecting the power source to at least one of the first electrode and the second electrode, and wherein the controller is in electrical communication with the electrical switch.

In an embodiment of the sample analysis system, the filtration system comprises: a second filter comprising: a second filter housing, wherein the second filter housing is electrically non-conductive; a second filter passage formed in the second filter housing and extending through the second filter housing; a third electrode at a first end of the second filter passage; a fourth electrode at a second end of the second filter passage; and a second filter screen in the second filter passage, wherein the second filter screen is between the third electrode and the fourth electrode. wherein the second filter is fluidically in parallel with the filter such that the first end of the second filter passage is fluidically connected to the blood cell chamber and the second end of the second filter passage is fluidically connected to the flow cell.

In an embodiment of the sample analysis system, the filtration system further comprises: a third valve fluidically connected between the blood cell chamber and the second filter passage, wherein the third valve comprises: a first mode that fluidically connects the blood cell chamber to the second filter passage while also fluidically disconnecting the second filter passage from the waste container; and a second mode that fluidically disconnects the blood cell chamber from the second filter passage while also fluidically connecting the second filter passage to the waste container; and a fourth valve fluidically connected between the second filter passage and the flow cell, wherein the fourth valve comprises: a first mode that fluidically connects the second filter passage to the flow cell while also fluidically disconnecting the second filter passage from the cleaning agent source; and a second mode that fluidically disconnects the second filter passage from the flow cell while also fluidically connecting the second filter passage to the cleaning agent source.

In an embodiment of the sample analysis system, the controller is in electrical communication with the third valve and the fourth valve, wherein the controller is configured to send a third control signal to the third valve and/or the fourth valve to simultaneously actuate both the third valve to the first mode of the third valve and the fourth valve to the first mode of the fourth valve, and wherein the controller is configured to send a fourth control signal to the third valve and/or the fourth valve to simultaneously actuate both the third valve to the second mode of the third valve and the fourth valve to the second mode of the fourth valve.

In an embodiment of the sample analysis system, the sample analysis system further comprises: a second electrical switch electrically connecting the power source to at least one of the third electrode and the fourth electrode, and wherein the controller is in electrical communication with the second electrical switch.

In an embodiment of the sample analysis system, the blood cell chamber is a white blood cell chamber, and the sample analysis system further comprises: a stain dispenser fluidically connected to the white blood cell chamber.

In another aspect of the disclosure, a filter assembly includes a filter housing that is electrically non-conductive. A filter passage extends through the filter housing. A first electrode at a first end of the filter passage and a second electrode is at a second end of the filter passage. A filter screen is in the filter passage and is between the first electrode and the second electrode.

The filter assembly of the preceding paragraph can optionally include, additionally and/or alternatively, any one or more of the following features, configurations and/or additional components in the paragraphs below.

In an embodiment of the filter assembly, the first electrode comprises a first tube-shaped body comprising a first electrode passage, wherein the first electrode passage is fluidically connected to the first end of the filter passage.

In an embodiment of the filter assembly, the first electrode passage is equal in diameter to the first end of the filter passage.

In an embodiment of the filter assembly, the second electrode comprises a second tube-shaped body comprising a second electrode passage, wherein the second electrode passage is fluidically connected to the second end of the filter passage.

In an embodiment of the filter assembly, the second electrode passage is equal in diameter to the second end of the filter passage.

In an embodiment of the filter assembly, the filter assembly further comprises: a first end cap connected to the first electrode, wherein the first end cap extends circumferentially around the first tube-shaped body of the first electrode, and wherein the first end cap connects the first electrode to the filter housing; and a second end cap connected to the second electrode, wherein the second end cap extends circumferentially around the second tube-shaped body of the second electrode, and wherein the second end cap connects the second electrode to the filter housing.

In an embodiment of the filter assembly, the first end cap is bonded to the filter housing, and wherein the second end cap is bonded to the filter housing.

In an embodiment of the filter assembly, the first end cap is connected to the filter housing by a first threaded connection between the first end cap and the filter housing, and wherein the second end cap is connected to the filter housing by a second threaded connection between the second end cap and the filter housing.

In an embodiment of the filter assembly, the first tube-shaped body comprises a first exterior threading extending circumferentially about the first tube-shaped body, and wherein the first exterior threading interfaces with a first interior threading of the filter housing.

In an embodiment of the filter assembly, the second tube-shaped body comprises a second exterior threading extending circumferentially about the second tube-shaped body, and wherein the second exterior threading interfaces with a second interior threading of the filter housing.

In an embodiment of the filter assembly, the first electrode and the second electrode are each formed from at least one of stainless steel, platinum, and palladium.

In an embodiment of the filter assembly, the filter screen is electrically non-conductive, and wherein the filter screen is spaced from both the first electrode and the second electrode such that the filter screen does not physically contact the first electrode nor the second electrode.

While the invention has been described with reference to an exemplary embodiment(s), it will be understood by those skilled in the art that various changes may be made and equivalents may be substituted for elements thereof without departing from the scope of the invention. For example, while testing apparatus 100 has been described above with reference to red blood cell samples and white blood cell samples, testing apparatus 100 can also be modified for screening and analysis of other biological fluid samples, such as urine. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A biological analysis system, comprising:
a conduit configured to convey a biological sample;
a filter positioned within the conduit; and
two electrodes, each electrode at opposing sides of the filter.

2. The system of claim 1, wherein the filter is a mesh filter and wherein the mesh filter is electrically non-conductive.

3. The system of claim 1, wherein the conduit comprises a first tubing section and a second tubing section.

4. The system as claimed in claim 3, wherein at least a portion of a first electrode of the two electrodes is located within the first tubing section, and at least a portion of the second electrode of the two electrodes is located within the second tubing section.

5. The system of claim 1, wherein each electrode of the two electrodes has a tubular cross-section.

6. The system of claim 1, further comprising: a housing, wherein the filter is positioned in the housing, and wherein each electrode has a threaded end configured to be secured to the housing.

7. A method of operating a filter in a biological analysis conduit, the method comprising:
directing a biological sample through the biological analysis conduit and through a screen of the filter in a first direction;
stopping flow of the biological sample through the biological analysis conduit and the screen;
applying electrical current across the screen of the filter by applying electrical current to a first electrode and a second electrode, wherein the screen of the filter is spaced between the first electrode and the second electrode; and
flushing the screen by flowing a cleaning fluid through the screen and the biological analysis conduit in a second direction opposite the first direction.

8. The method of claim 7, further comprising:
flowing the cleaning fluid through the screen at a flowrate that is two to three times faster than a flowrate of the biological sample through the screen.

9. The method of claim 7, further comprising:
directing the cleaning fluid to a waste container after flushing the screen.

10. The method of claim 7, further comprising:
priming the biological analysis conduit and the filter by flowing a second biological sample through the biological analysis conduit and through the screen of the filter in the first direction after flushing the screen.

11. The method of claim 10, wherein priming the biological analysis conduit and the filter further comprises:
staining the second biological sample before flowing the second biological sample through the biological analysis conduit and through the screen of the filter in the first direction; and
diluting the second biological sample before flowing the second biological sample through the biological analysis conduit and through the screen of the filter in the first direction.

12. The method of claim 7, further comprising:
stopping flow of the cleaning fluid through the screen and the biological analysis conduit in the second direction;
passing electrical current across the screen again by reapplying electrical current to the first electrode and the second electrode; and
flushing the screen a second instance by restarting flow of the cleaning fluid through the screen and the biological analysis conduit in the second direction.

13. A filter assembly comprising:
a filter housing, wherein the filter housing is electrically non-conductive;
a filter passage extending through the filter housing;
a first electrode at a first end of the filter passage;
a second electrode at a second end of the filter passage; and
a filter screen in the filter passage, wherein the filter screen is between the first electrode and the second electrode.

14. The filter assembly of claim 13, wherein the first electrode comprises:
a first tube-shaped body comprising a first electrode passage, wherein the first electrode passage is fluidically connected to the first end of the filter passage, and wherein the first electrode passage is equal in diameter to the first end of the filter passage.

15. The filter assembly of claim 14, wherein the second electrode comprises:
a second tube-shaped body comprising a second electrode passage, wherein the second electrode passage is fluidically connected to the second end of the filter passage, and wherein the second electrode passage is equal in diameter to the second end of the filter passage.

16. The filter assembly of claim 15, further comprising:
a first end cap connected to the first electrode, wherein the first end cap extends circumferentially around the first tube-shaped body of the first electrode, and wherein the first end cap connects the first electrode to the filter housing; and
a second end cap connected to the second electrode, wherein the second end cap extends circumferentially around the second tube-shaped body of the second electrode, and wherein the second end cap connects the second electrode to the filter housing.

17. The filter assembly of claim 16, wherein the first end cap is connected to the filter housing by a first threaded connection between the first end cap and the filter housing, and wherein the second end cap is connected to the filter housing by a second threaded connection between the second end cap and the filter housing.

18. The filter assembly of claim 15, wherein the first tube-shaped body comprises a first exterior threading extending circumferentially about the first tube-shaped body, wherein the first exterior threading interfaces with a first interior threading of the filter housing, wherein the second tube-shaped body comprises a second exterior threading extending circumferentially about the second tube-shaped body, and wherein the second exterior threading interfaces with a second interior threading of the filter housing.

19. The filter assembly of claim 13, wherein the first electrode and the second electrode are each formed from at least one of stainless steel, platinum, and palladium.

20. The filter assembly of claim 13, wherein the filter screen is electrically non-conductive, and wherein the filter screen is spaced from both the first electrode and the second electrode such that the filter screen does not physically contact the first electrode nor the second electrode.
